(19) United States
(12) Patent Application Publication
(10) Pub. No.: US 2026/0231243 A1
(43) Pub. Date: Aug. 6, 2026

(54) CONTROLLING RETRANSMISSION DELAY OF PHYSICAL RANDOM ACCESS CHANNEL (PRACH) TRANSMISSION

(71) Applicant: SHARP KABUSHIKI KAISHA, Osaka (JP)

(72) Inventors: Tomoki YOSHIMURA, Camas, WA (US); Zhanping YIN, Vancouver, WA (US); Sangkyu BAEK, Vancouver, WA (US)

(21) Appl. No.: 19/044,492

(22) Filed: Feb. 3, 2025

(51) Int. Cl. H04W 74/0833; H04L 1/08

(52) U.S. Cl. CPC H04W 74/085; H04L 1/08

(57) ABSTRACT

A user equipment (UE) selects a first random access channel occasion (RO). The UE initiates a random access (RA) procedure by transmitting, to a base station (BS), an RA preamble in the first RO. The UE receives, from the BS, an RA response (RAR) indicating an uplink for a message 3 (Msg3) is not granted. The UE select a second RO. In a case that the first RO is within a subband full duplex (SBFD) region in time domain, the UE calculates a backoff time as a function of a first scaling factor. In a case that the first RO is within a non-SBFD region in the time domain, the UE calculates the backoff time as a function of a second scaling factor different from the first scaling factor. The UE retransmits, to the BS, the RA preamble in the second RO after a duration of the calculated backoff time.

### TECHNICAL FIELD

The technology generally relates to wireless communications, and more particularly to controlling the transmission power of Physical Uplink shared Channel (PUSCH) during Random Access (RA) procedure.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions; and at least one processor coupled to the one or more non-transitory computer-readable media. The at least one processor is configured to execute the one or more computer-executable instructions to cause the UE to select a first random access channel occasion (RO) from a first group of ROs; initiate an RA procedure by transmitting, to a base station (BS), an RA preamble in the first RO; receive, from the BS, an RA response (RAR) indicating an uplink for a message 3 (Msg3) is not granted; select a second RO from a second group of ROs; in a case that the first RO is within a subband full duplex (SBFD) region in time domain, calculate a backoff time as a function of a first scaling factor; in a case that the first RO is within a non-SBFD region in the time domain, calculate the backoff time as a function of a second scaling factor different from the first scaling factor; and retransmit, to the BS, the RA preamble in the second RO after a duration of the calculated backoff time.

In an implementation of the first aspect, the RAR includes a backoff indicator (BI). Calculating the backoff time as a function of the first scaling factor includes calculating a preamble backoff value by multiplying the BI by the first scaling factor, and selecting the backoff time as a random value between 0 and the preamble backoff value. Calculating the backoff time as a function of the second scaling factor includes calculating a preamble backoff value by multiplying the BI by the second scaling factor, and selecting the backoff time as a random value between 0 and the preamble backoff value.

In another implementation of the first aspect, the RAR identifies the second RO to be within the SBFD region or the non-SBFD region for the retransmission of the RA preamble.

In another implementation of the first aspect, the UE is one of several UEs to which the RAR is broadcast by the BS.

In another implementation of the first aspect, the at least one processor is further configured to execute the one or more computer-executable instructions to cause the UE to receive, from the BS, the first scaling factor, as a first radio resource control (RRC) parameter associated with the SBFD region; and receive, from the BS, the second scaling factor, as a second RRC parameter associated with the non-SBFD region, wherein the first and second RRC parameters are received via one or more RRC messages.

In another implementation of the first aspect, the at least one processor is further configured to execute the one or more computer-executable instructions to cause the UE to receive, from the BS, a second RAR corresponding to the retransmitted RA preamble within a RAR time window, the second RAR includes an uplink grant for a message 3 (Msg3) of the RA procedure; and transmit, to the BS, the Msg3 in response to receiving the second RAR.

In another implementation of the first aspect, the at least one processor is further configured to execute the one or more computer-executable instructions to cause the UE to: for a number of times and before reaching a maximum number of RA preamble transmission attempts, iteratively: receive, from the BS, an RAR indicating an uplink for a Msg3 is not granted; select a next RO for transmission of the RA preamble; in a case that an immediately transmitted RO is within the SBFD region in the time domain, calculate the backoff time as a function of the first scaling factor, in a case that the immediately transmitted RO is within the non-SBFD region in the time domain, calculate the backoff time as a function of the second scaling factor, and retransmit, to the BS, the RA preamble in the next RO after a duration of the calculated backoff time.

In a second aspect of the present application, a UE is provided. The UE includes one or more non-transitory computer-readable media storing one or more computer-executable instructions; and at least one processor coupled to the one or more non-transitory computer-readable media. The at least one processor is configured to execute the one or more computer-executable instructions to cause the UE to select a first RO from a first group of ROs; initiate an RA procedure by transmitting, to a BS, an RA preamble in the first RO; receive, from the BS, an RAR indicating an uplink for a Msg3 is not granted; select a second RO from a second group of ROs; in a case that the RAR is received within the SBFD region in time domain, calculate a backoff time as a function of a first scaling factor; in a case that the RAR is received within the non-SBFD region in the time domain, calculate the backoff time as a function of a second scaling factor different than the first scaling factor; and retransmit, to the BS, the RA preamble in the second RO after a duration of the calculated backoff time.

In an implementation of the second aspect, the RAR includes a BI. Calculating the backoff time as a function of the first scaling factor includes calculating a preamble backoff value by multiplying the BI by the first scaling factor, and selecting the backoff time as a random value between 0 and the preamble backoff value. Calculating the backoff time as a function of the second scaling factor includes calculating a preamble backoff value by multiplying the BI by the second scaling factor, and selecting the backoff time as a random value between 0 and the preamble backoff value.

In another implementation of the second aspect, the RAR identifies the second RO to be within the SBFD or the non-SBFD region for the retransmission of the RA preamble.

In another implementation of the second aspect, the UE is one of several UEs to which the RAR is broadcast by the BS.

In another implementation of the second aspect, the at least one processor is further configured to execute the one or more computer-executable instructions to cause the UE to receive, from the BS, the first scaling factor as an RRC parameter associated with the SBFD region, and the second scaling factor is received, from the BS, as an RRC parameter associated with the non-SBFD region, wherein the first and second RRC parameters are received via one or more RRC messages.

In another implementation of the second aspect, the at least one processor is further configured to execute the one or more computer-executable instructions to cause the UE to receive, from the BS, a second RAR corresponding to the retransmitted RA preamble within a RAR time window, the second RAR includes an uplink grant for a Msg3 of the RA procedure; and transmit, to the BS, the Msg3 in response to receiving the second RAR.

In another implementation of the second aspect, the at least one processor is further configured to execute the one or more computer-executable instructions to cause the UE to: for a number of times and before reaching a maximum number of RA preamble transmission attempts, iteratively: receive, from the BS, an RAR indicating an uplink for a Msg3 is not granted; select a next RO for transmission of the RA preamble; in a case that a last RAR is received within the SBFD region in the time domain, calculate the backoff time as a function of a first scaling factor; in a case that the last RAR is received within the non-SBFD region in the time domain, calculate the backoff time as a function of a second scaling factor different than the first scaling factor; and retransmit, to the BS, the RA preamble in the next RO after a duration of the calculated backoff time.

In a third aspect of the present application, a method is provided. The method includes selecting, by a UE, a first RO from a first group of ROs; initiating, by the UE, an RA procedure by transmitting, to a BS, an RA preamble in the first RO; receiving, from the BS, an RAR indicating an uplink for a Msg3 is not granted; selecting a second RO from the second group of ROs; in a case that the first RO is within an SBFD region in time domain, calculating a backoff time as a function of a first scaling factor; in a case that the first RO is within a non-SBFD region in the time domain, calculating the backoff time as a function of a second scaling factor different from the first scaling factor; and retransmitting, to the BS, the RA preamble in the second RO after a duration of the calculated backoff time.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a time-frequency diagram illustrating an example resource partitioning in a serving cell, according to an example implementation of the present disclosure.

FIGS. 9A-9B illustrate a flowchart of an example method/process of a CBRA procedure performed by a terminal device, according to an example implementation of the present disclosure.

FIGS. 10A-10B illustrate a flowchart of an example method/process performed by a terminal device to determine the PRACH transmission power using two power ramping counters, according to an example implementation of the present disclosure.

FIG. 11 is a flowchart illustrating an example method/process performed by a terminal device to determine the PRACH transmission power using two preamble received target powers, according to an example implementation of the present disclosure.

FIG. 12 illustrates a flowchart of an example method/process of determining the backoff time for transmitting a PRACH based on which region the last RO is transmitted, according to an example implementation of the present disclosure.

FIG. 13 illustrates a flowchart of an example method/process of determining the backoff time for transmitting a PRACH based on the region in which the last RAR is received, according to an example implementation of the present disclosure.

FIG. 14 is an example flow diagram of the random-access procedure, according to an example implementation of the present disclosure.

FIG. 15 illustrates a flowchart of an example method/process of determining the PUSCH transmission power during the random access procedure, according to an example implementation of the present disclosure.

FIGS. 16 and 17 illustrate two TPC tables that may be used for determining the PUSCH transmission power, according to an example implementation of the present disclosure.

FIGS. 18 and 19 are example flow diagrams of the random-access procedure, where the PRACH transmission may be performed in two different regions, according to an example implementation of the present disclosure.

FIGS. 20A-20B illustrate a flowchart of an example method/process performed by a terminal device to determine the PRACH transmission power using a power ramping counter, according to an example implementation of the present disclosure.

FIG. 21 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/of” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6gNB), and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive subcarrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)\hat{ }(IX) indicates IX to the power of HX.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

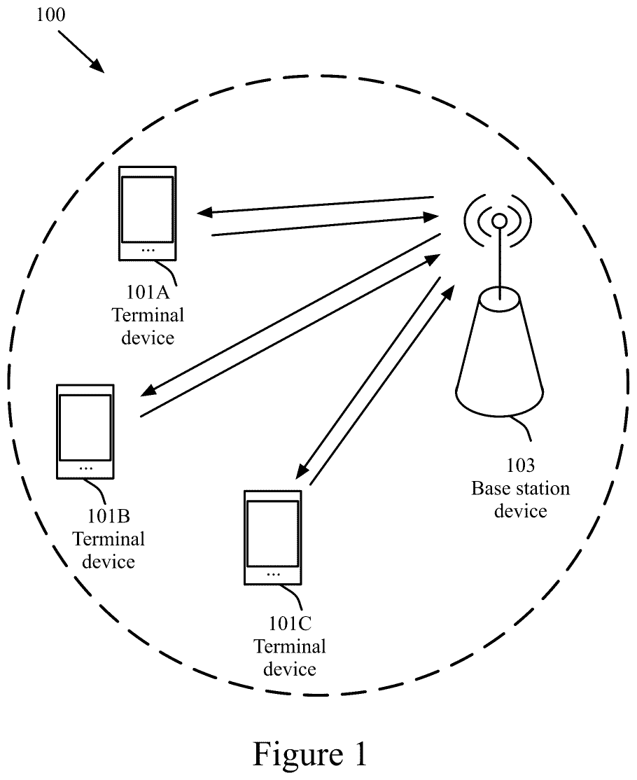

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When the BS 103 is configured with multiple transmission/reception devices, each of the multiple transmission/reception devices may be arranged at a different position. A transmission/reception device may include a transmission device and/or a reception device.

The BS 103 may serve radio communication and provide one or more cells. A cell is defined in this disclosure as a set of resources used for a wireless communication. A cell may include one or both of a downlink component carrier and an uplink component carrier. A serving cell may include a downlink component carrier and two or more uplink component carriers.

One or more SubCarrier Spacing-specific (SCS-specific) carriers may be associated with one component carrier. Each SCS-specific carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

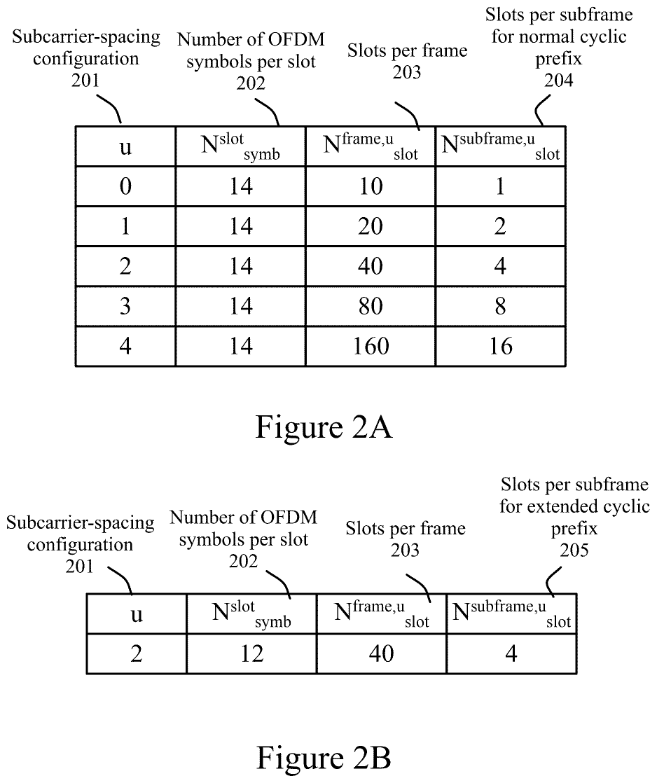

FIGS. 2A and 2B are two diagrams illustrating parameters related to SCS-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame, u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In 6G radio, a new time unit may be introduced. The new time unit N^{new-unit}_{symb} may for example be a multiple of 14.

In FIG. 2A, for example, when the subcarrier-spacing configuration u 201 is set to 2 and the CP configuration is set to normal Cyclic Prefix CP), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

Value range of N^{new-unit}_{symb} may be different in respective subcarrier-spacing configuration u. For example, the value range of N^{new-unit}_{symb} may be 1 and 2 for u=0, 1, 2, 3, and 4 for u=1, 1, 2, 4, 8, and 16 for u=2.

The time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(df_{ref}N_{f, ref}). The constant k is 64 when df_{ref} is 15 kHz and N_{f, ref} is 2048.

In 6G radio, N_{f} may be equal to or larger than 4096. For example, N_{f} may be 8192 or 16384.

Radio transmissions in the downlink and/or radio transmissions in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame may include ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

The SCS of the OFDM-based waveform may be calculated by subcarrier-spacing configuration u. For example, the SCS may be calculated by 15000*2^{u}.

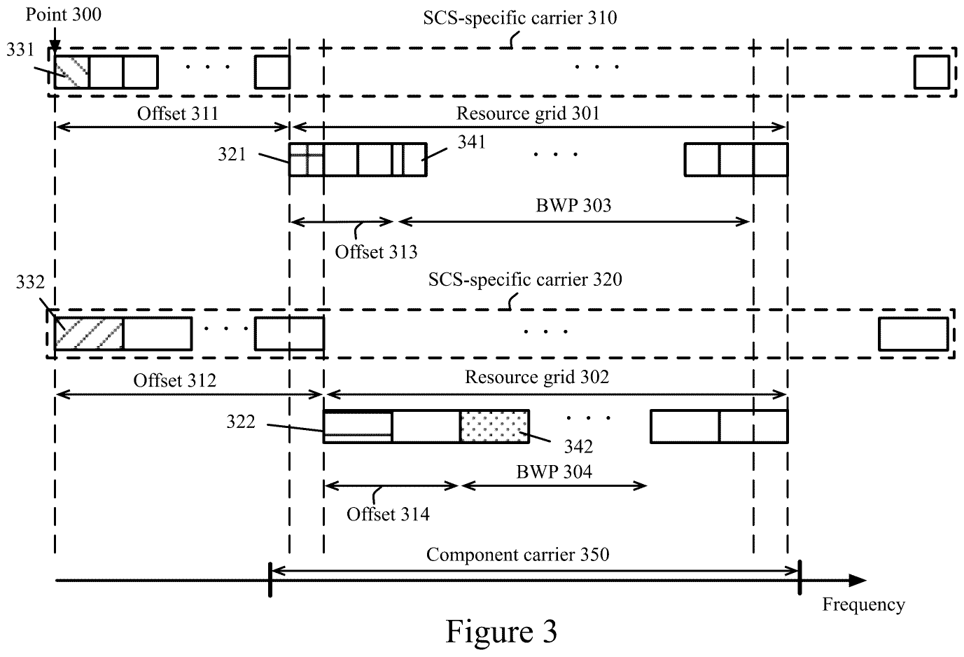

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

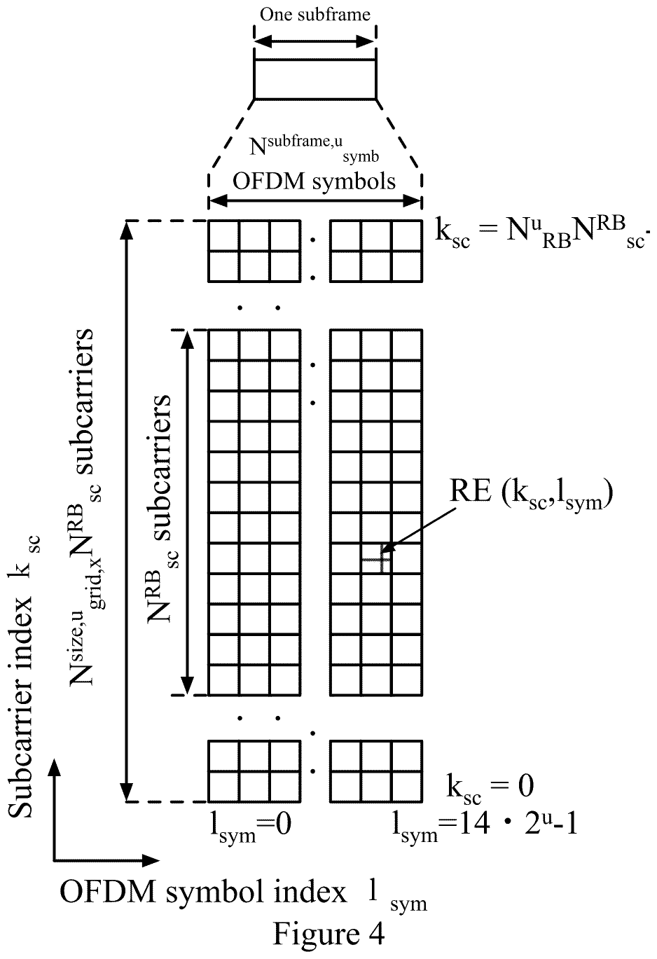

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as (Resource Element (RE).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size, u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

The new time unit may be a time unit in which the transmitter assumes that the receiver may combine received Demodulation Reference Signal (DMRS) symbols in the new time unit. By combining the DMRS symbols in the new time unit, the receiver may perform channel estimation. For example, the transmitter may determine to maintain phase continuity and/or power consistency in the new time unit.

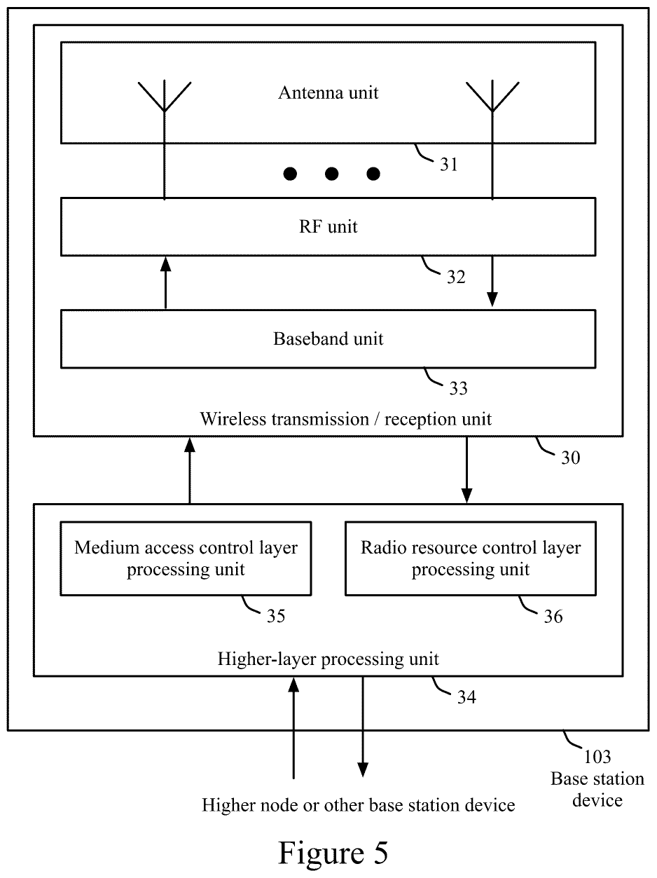

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

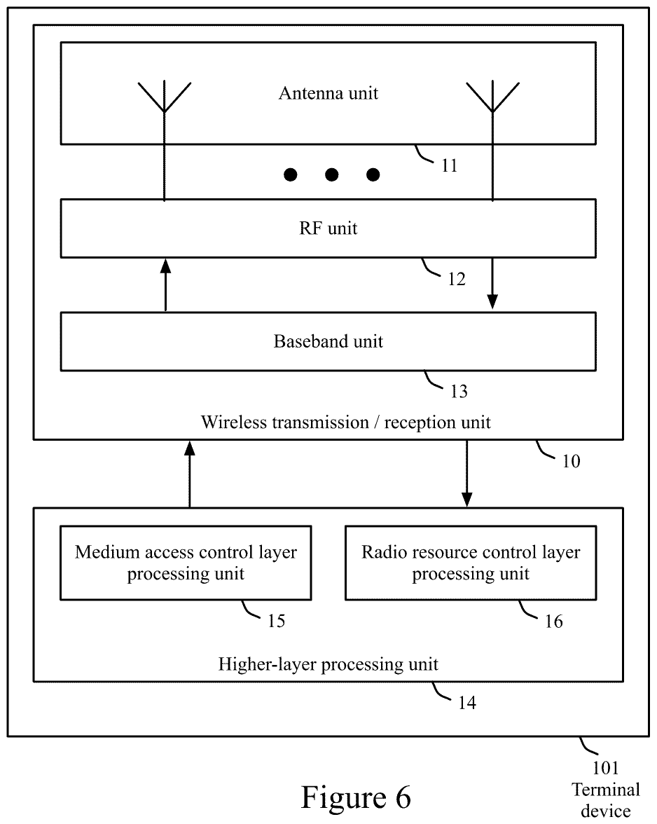

FIG. 6 is a schematic block diagram illustrating a configuration example of a terminal device, according to an example implementation of the present disclosure. The terminal device 101 may be any of the terminal devices 101A-101C, shown in FIG. 1. As shown in FIG. 6, the terminal device 101 may include a part or all of the wireless transmission and reception unit (also referred to herein as physical layer processing unit or physical layer unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit (also referred to as the MAC entity) 15 and the RRC layer processing unit 16. The higher-layer processing unit 14 may include at least one processor (e.g., as shown in the figure illustrating the block diagram of a node for wireless communication) and one or more non-transitory computer-readable media (e.g., as shown in the figure illustrating the block diagram of the node for wireless communication) that store computer-executable instructions and data. For example, the processor of the terminal device 101 may perform several processes, described below, in the MAC layer processing unit (the MAC entity) 15 and the wireless transmission and reception unit (the physical layer unit) 10.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

The CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access (RA) preamble. A PRACH may be sent to deliver (transmit, convey) an index of a random-access preamble. The terminal device 101 may transmit a PRACH. The base station device 103 may receive the PRACH.

For a given PRACH occasion (RACH occasion, RO), 64 random-access preambles are defined. The random-access preamble is specified (determined, given) based on the cyclic shift Cᵥ of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UL DMRS, Sounding Reference Signal (SRS), UpLink Phase Tracking Reference Signal (UL PT-RS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

The DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

In 6G radio, a TDRA field may indicate the time resource within the new time unit. For example, the TDRA field may indicate the starting OFDM symbol S in the new time unit and the length L in terms of OFDM symbols. In a case that the N^{new-unit}_{symb} is larger than N^{slot}_{symb}, the physical channel scheduled by the TDRA field may cross the slot boundary.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 01 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 10 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

In 6G radio, the PDSCH-to-HARQ-feedback timing indicator field may be used to indicate the offset (K1) from a new time unit in which the last OFDM symbol of a PDSCH scheduled by the DCI format is included to another new time unit in which the first OFDM symbol of a PUCCH triggered by the DCI format 1_0 is mapped.

In 6G radio, the PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 11 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), Channel State Information-Reference Signal (CSI-RS), and DownLink Phase Tracking Reference Signal (DL PT-RS) may be used.

A synchronization signal may be used to synchronize in the frequency domain and time domain for downlink. The synchronization signal is a generic name of Primary Synchronization Signal (PSS) and Secondary Synchronization Signal (SSS).

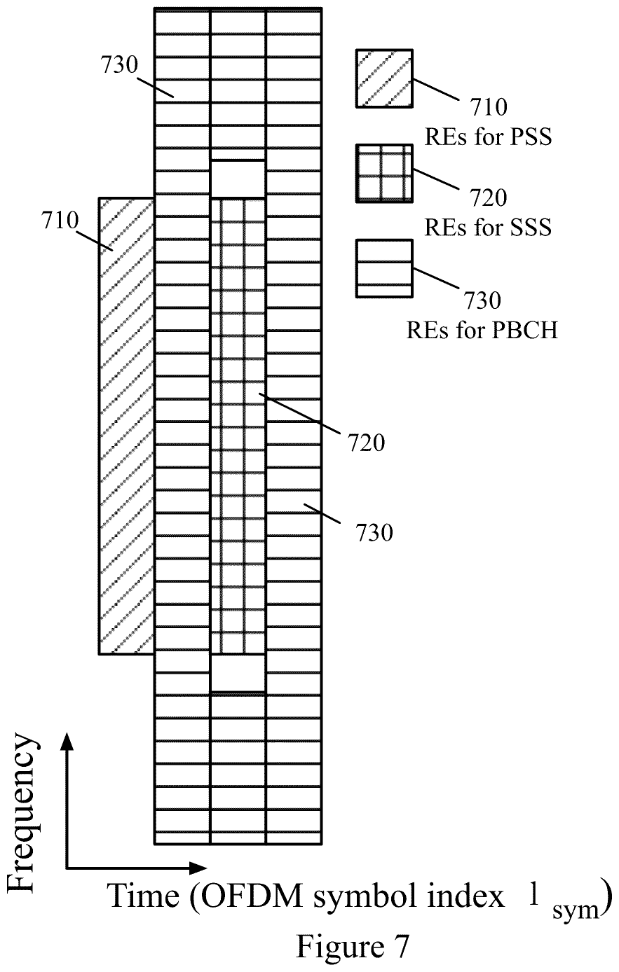

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index l_{sym}, and the vertical axis represents the frequency domain. The shaded blocks 710 represent a set of REs for the PSS. The block of grid lines 720 represents a set of REs for the SSS. Also, the blocks in the horizontal line 730 represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A Broadcast Channel (BCH), an Uplink-Shared Channel (UL-SCH), and a Downlink-Shared Channel (DL-SCH) are transport channels. A channel used in the MAC layer is called a transport channel. A unit of transport channel used in the MAC layer is also called transport block (TB) or MAC Protocol Data Unit (MAC PDU). In the MAC layer, control of Hybrid Automatic Repeat request (HARQ) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A Broadcast Control Channel (BCCH), a Common Control Channel (CCCH), and a Dedicated Control Channel (DCCH) are logical channels. The BCCH is a channel of the RRC layer used to deliver MIB or other system information blocks. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The BS 103 may indicate change of cell-specific parameters by reconfiguration with random-access. The BS 103 may indicate change of UE-specific parameters by reconfiguration with or without random-access.

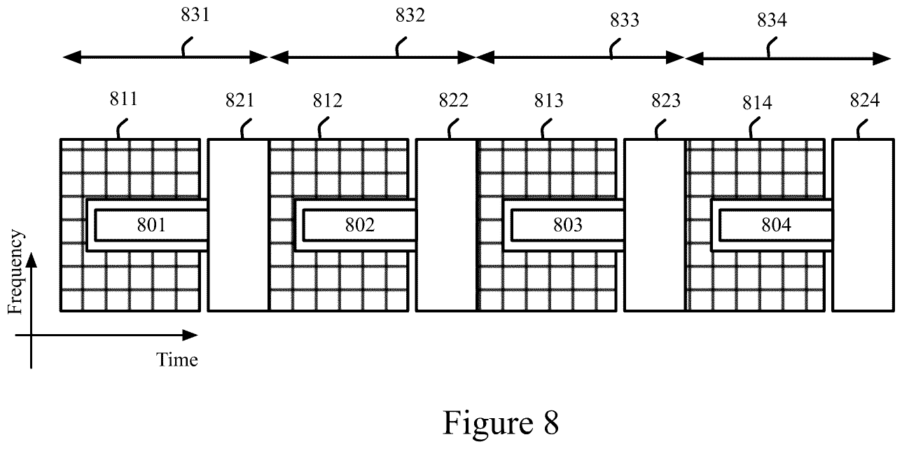

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the time division duplexing (TDD) pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern may be configured based on one or more RRC parameters provided by the RRC layer. The length of the pattern may be configured based on one or more RRC parameters provided by the RRC layer.

The UL subband may be configured in one or both of the DL region and the time domain guard period. The time domain resource of the UL subband may be configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3rd slot, and the length is 11 slots, the terminal device 101 determines that the UL subband with length of 11 slots starting at the 3rd slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

Random-access (RA) may be used for various purposes. For example, RA may be used for scheduling requests or uplink timing synchronization. The RA procedures are crucial for establishing initial communication between the UE and the network, in scenarios such as initial network access, handovers, and when the UE needs to move from an idle state to a connected state.

At least two modes are available for RA: (1) Contention-Based Random-Access (CBRA) and (2) Contention-Free Random-Access (CFRA). In a CBRA procedure, the UE may select an RA preamble from a pool shared with other UEs. In a CBRA procedure, multiple UEs may select the same preamble. In a CFRA procedure, the BS may allocate a dedicated RA preamble for the UE to ensure different UEs use different preambles.

### PRACH Transmission Power Control

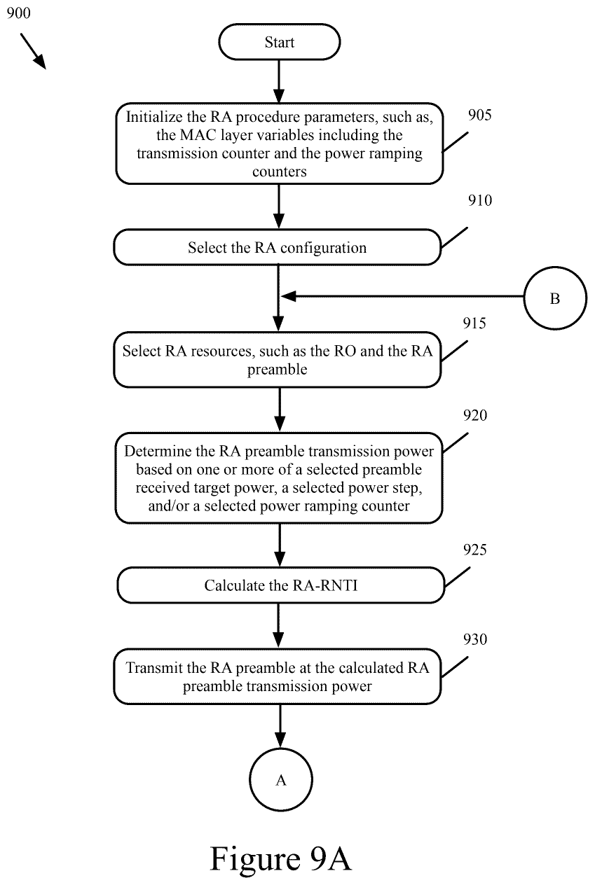

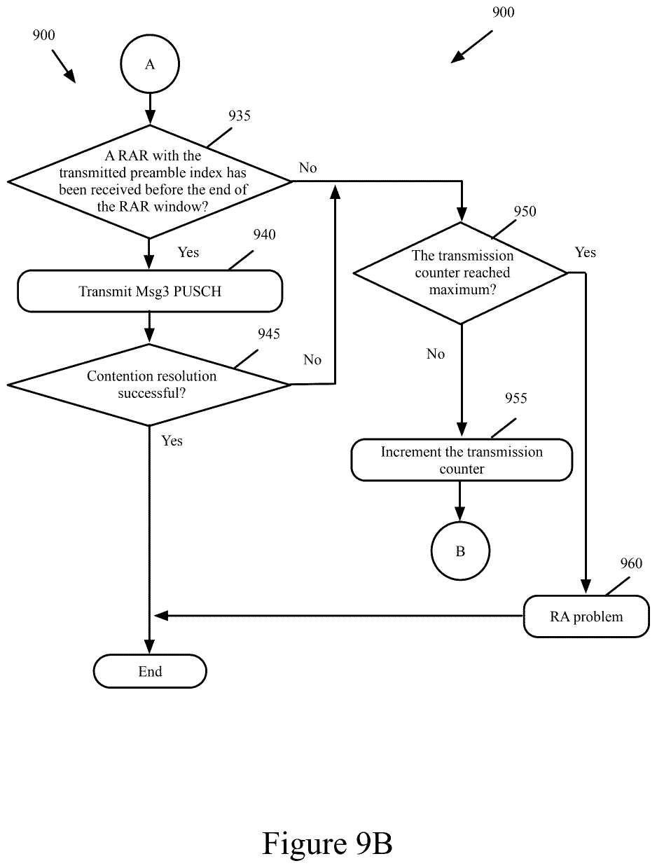

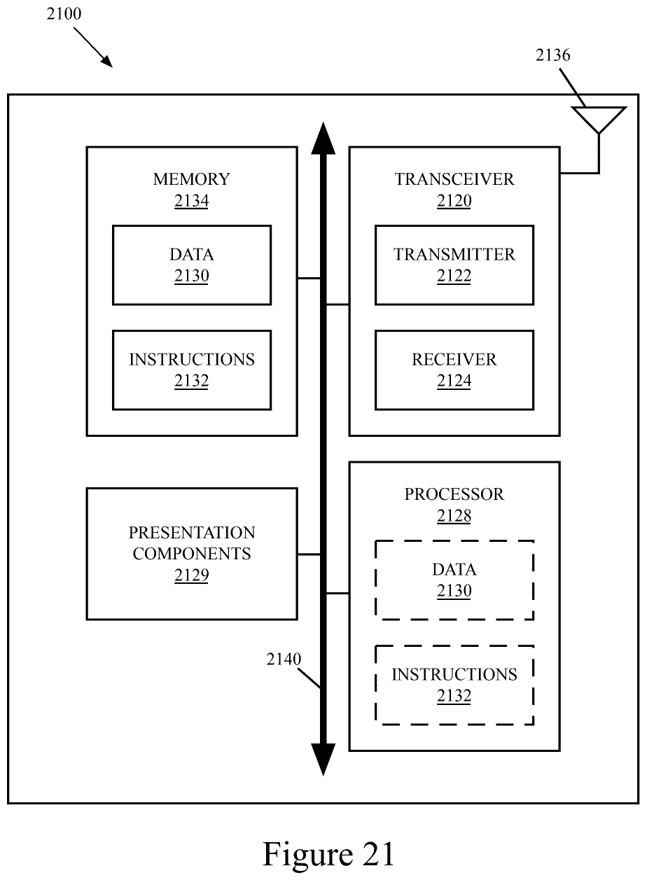

FIGS. 9A-9B illustrate a flowchart of an example method/process 900 of a CBRA procedure performed by a terminal device, according to an example implementation of the present disclosure. The process 900 may be performed by at least one processor of the terminal device 101, shown in FIGS. 6 and 21.

The process 900 may initialize (at block 905) the RA procedure parameters. For example, the terminal device 101 may reset MAC layer parameters, such as, a part or all of a transmission counter C_{TX}, and a power ramping counter Cₚ. For example, the terminal device 101 may set the C_{TX} to 1 and the MAC entity may set the Cₚ to 1. The MAC entity, in some embodiments, may use two power ramping counters Cₚ₁ and Cₚ₂. The two power ramping counters Cₚ₁ and Cₚ₂ may, for example, be initialized to 1.

The process 900 may select (at block 910) the RA configuration. In a case that the terminal device 101 is provided with multiple RA configurations, the MAC entity may select an RA configuration from the multiple RA configurations. In a case that the terminal device 101 is provided with multiple feature combinations, the MAC entity may select one feature combination suitable for the RA. Each feature combination may be associated with the respective RA configurations. The example of the features may include coverage enhancement (CovEnh) to indicate the need for coverage enhancement to the network, slicing to indicate the need for prioritization and isolation of a slice to the network, reduced capabilities (RedCap) to indicate the reduced capabilities of the UE to the network, small data transmission (SDT) to indicate the small data transmission procedure, etc.

The process 900 may select (at block 915) the RA resources. In the RA resource selection, an RA preamble index may be selected. Furthermore, an RA channel occasion (RO) may be selected for PRACH transmission. An RA configuration may provide multiple ROs over time-frequency domain. For example, with reference to FIG. 8, several ROs may be provided in the SBFD regions 801-804 and/or in the non-SBFD regions 821-824. Some of the ROs may be partially in an SBFD region 801-804 and partially in a non-SBFD region 821-824.

Each RO may be associated with one or more SS/PBCH block indices. The terminal device 101 may determine the association between the SS/PBCH blocks and the ROs. In a case where a single SS/PBCH block is configured, the terminal device 101 may determine that all the ROs derived from the selected RA configuration are associated with the single SS/PBCH block. In a case where multiple SS/PBCH blocks with different indices are configured, the terminal device 101 may select one SS/PBCH block from the multiple SS/PBCH blocks. The terminal device 101 may determine one RO associated with the selected SS/PBCH block using the association between the SS/PBCH blocks and ROs.

The process 900 may determine (at block 920) a transmission power for transmission of the RA preamble based on one or more of a selected preamble received target power, a selected power step, and/or a selected power ramping counter. The RA preamble may be transmitted using the selected RA preamble index and the selected RO. The terminal device may transmit the PRACH using a transmission power that is determined based on a parameter PREAMBLE_RECEIVED_TARGET_POWER (referred to as P_{target}). The parameter P_{target} may be calculated using the power ramping counter Cₚ. For example, P_{target} may be calculated as shown in Equation (1):

$${P}_{target} = {p}_{configured} + Δ + ( {C}_{p} - 1 ) * {P}_{step} \qquad Equation ( 1 )$$

Here, p_{configured} is a value provided by one or more RRC parameters. The p_{configured} may be a value representing a configured preamble received target power for the PRACH, A is a value associated with a preamble format used to transmit the PRACH, and Pₛₜₑₚ is a value representing the step of power ramping. The Pₛₜₑₚ may be determined by one or more RRC parameters.

As described below, the terminal device 101 may select a different configured preamble received target power p_{configured}, a different power ramping step pₛₜₑₚ and/or a different power ramping counter Cₚ, based on whether the selected RO is in an SBFD region (e.g., one of the regions 801-804 shown in FIG. 8) and/or in a non-SBFD region (e.g., one of the regions 821-824 shown in FIG. 8).

The terminal device 101 may transmit a PRACH using the selected random-access preamble index and the RO. The terminal device 101 may determine transmission power P_{PRACH} for the PRACH. The terminal device may determine the transmission power P_{PRACH} using the parameter P_{target}. For example, the transmission power P_{PRACH} may be calculated as shown in Equation (2):

$${P}_{PRACH} = min ( {P}_{CMAX} , {P}_{target} + PL ) \qquad Equation ( 2 )$$

Here, P_{CMAX} denotes the configured maximum transmission power for the serving cell. The PL is the pathloss, and may be calculated based on the difference between the transmission power of the BS and the power of the signals received by the terminal device. The BS may determine the downlink transmission power based on the network planning and configuration, and may send it to the terminal as, the parameter referenceSignalPower. The referenceSignalPower may be provided, by the BS, to the terminal device by one or more RRC parameters. The one or more RRC parameters may include an RRC parameter representing SS/PBCH block transmission power. The UE may measure the reference signal received power (RSRP), and may calculate the PL as the difference between the referenceSignalPower and the RSRP.

The RSRP may be an unfiltered RSRP or a higher layer filtered RSRP. The RSRP may be calculated via measurement of the SS/PBCH blocks with the selected SS/PBCH block index. It should be noted that the detectability of the PRACH by the BS depends on the received power at the BS. Therefore, the transmission power for the PRACH (e.g., the P_{PRACH} calculated by Equation (2)) is calculated as a function of the received power by the BS (e.g., the P_{target} calculated in Equation (1)).

In the RA, for a terminal device 101 that is capable of PRACH transmission in the SBFD regions, different power control parameters may be used for PRACH transmissions in the SBFD regions and PRACH transmissions in the non-SBFD regions. For example, one RACH resource configuration may include two different power control settings.

The first power control setting may include RRC parameters for the SBFD regions (e.g., one of the regions 801-804 shown in FIG. 8). The second power control setting may include RRC parameters for the non-SBFD regions (e.g., one of the regions 821-824 shown in FIG. 8).

The terminal device 101, in some embodiments, may adaptively select one of two configured preamble received target powers, p_{configured,first} and p_{configured,second}, to use as the p_{configured} in Equation (1). The first power control setting may include a first RRC parameter that is used to determine the configured preamble received target power p_{configured,first}. The second power control setting may include a second RRC parameter that is used to determine the configured preamble received target power p_{configured,second}.

Given that ROs may be distributed in the SBFD region and the non-SBFD region, the terminal device 101 may select the earliest ROs available for each retransmission of the PRACH. On the other hand, radio link quality of the SBFD region and the non-SBFD region may be different, e.g., due to the existence of cross link interference in the SBFD region. Therefore, adaptive power control per retransmission attempt provides the technical advantage of providing flexibility in selecting an RO for the retransmission of the PRACH and reducing the latency in the retransmission of the PRACH.

The terminal device 101 may select one of the p_{configured,first} and p_{configured,second} configured preamble received target powers after the RO preamble selection has been done. The terminal device 101 may select one of the p_{configured,first} and p_{configured,second} preamble received target powers based on the selected RO.

The followings are examples of different criteria that the terminal device 101 may use to select one of the p_{configured},first and p_{configured,second} configured preamble received target powers. The terminal device 101 may select one of the p_{configured,first} and p_{configured,second} configured preamble received target powers based on whether the selected RO is in the SBFD region. For example, the terminal device 101 may select p_{configured,first} in a case that the selected RO is in the SBFD region and the MAC entity may select p_{configured,second} in a case that the selected RO is not in the SBFD region.

The terminal device 101 may select one of the p_{configured,first} and p_{configured,second} configured preamble received target powers in a case that the RO is in both the SBFD region and the non-SBFD region. The terminal device 101 may select one of the p_{configured,first} and p_{configured,second} preamble received target powers based on whether the selected RO is at least partially in the SBFD region.

The terminal device 101 may select the p_{configured,first} in a case that the selected RO is at least partially in the SBFD region, and the MAC entity may select the p_{configured,second} in a case that the selected RO is not even partially in the SBFD region.

The terminal device 101 may select one of the p_{configured,first} and p_{configured,second} preamble received target powers based on whether the selected RO is fully in the SBFD region. For example, the MAC entity may select the p_{configured,first} in a case that the selected RO is fully in the SBFD region, and the MAC entity may select the p_{configured,second} in a case that the selected RO is not fully in the SBFD region.

The terminal device 101 may select the p_{configured,first} in a case that the selected RO is both in the SBFD region and the non-SBFD region. The MAC entity may select the p_{configured,second} in a case that the selected RO is both in the SBFD region and the non-SBFD region.

An RRC parameter may be provided to the terminal device 101 which is used to determine which of the p_{configured,first} and p_{configured,second} is selected in a case that the selected RO is both in the SBFD region and the non-SBFD region.

In a case that the terminal device 101 selected one of the parameters p_{configured,first} and p_{configured,second}, the MAC entity may calculate the P_{target} by using the selected parameter as the p_{configured} in Equation (1).

The terminal device 101 may adaptively select one of the two values p_{step,first} and p_{step,second} to use as the power ramping step, pₛₜₑₚ, in Equation (1). The first power control setting may include a third RRC parameter used to determine the p_{step,first}. The second power control setting may include a fourth RRC parameter used to determine the p_{step,second}. The terminal device 101 may select one of the p_{step,first} and p_{step,second} power ramping steps after the RA preamble selection has been done.

The followings are examples of different criteria that the terminal device 101 may use to select one of the p_{step,first} and p_{step,second} power ramping steps. The MAC entity may select one of the p_{step,first} and p_{step,second} power ramping steps based on the selected RO. The MAC entity may select one of the p_{step,first} and p_{step,second} power ramping steps based on whether the selected RO is in the SBFD region. For example, the terminal device 101 may select p_{step,first} in a case that the selected RO is in the SBFD region, and the terminal device 101 may select p_{step,second} in a case that the selected RO is not in the SBFD region.

The terminal device 101 may select one of the p_{step,first} and p_{step,second} power ramping steps in a case that the RO is in both the SBFD region and the non-SBFD region. The MAC 15 entity may select one of the p_{step,first} and p_{step,second} power ramping steps based on whether the selected RO is at least partially in the SBFD region. For example, the terminal device 101 may select the p_{step,first} in a case that the selected RO is at least partially in the SBFD region, and the MAC entity may select the p_{step,second} in a case that the selected RO is not even partially in the SBFD region.

The terminal device 101 may select one from p_{step,first} and p_{step,second} power ramping steps based on whether the selected RO is fully in the SBFD region. For example, the terminal device 101 may select the p_{step,first} in a case that the selected RO is fully in the SBFD region, and the MAC entity may select the p_{step,second} in a case that the selected RO is not fully in the SBFD region.

The terminal device 101 may select the p_{step,first} in a case that the selected RO is both in the SBFD region and the non-SBFD region. The terminal device 101 may select the p_{step,second} in a case that the selected RO is both in the SBFD region and the non-SBFD region.

In some embodiments, an RRC parameter may be provided to the terminal device 101 which is used to determine which of the p_{step,first} and p_{step,second} power ramping steps is selected in a case that the selected RO is both in the SBFD region and the non-SBFD region.

In a case that the terminal device 101 selected one of the parameters p_{step,first} and p_{step,second}, the terminal device 101 may calculate the P_{target} by using the selected parameter as the pₛₜₑₚ in Equation (1).

The terminal device 101, in some embodiments, may adaptively select one of the two power ramping counters, Cₚ₁ and Cₚ₂ to use as the Cₚ in Equation (1). The MAC entity may select one of the power ramping counters Cₚ₁ and Cₚ₂ after the RA preamble selection has been done.

The MAC 15 entity may select one of the Cₚ₁ and Cₚ₂ power ramping counters based on the selected RO. The terminal device 101 may use different criteria for selecting one of the Cₚ₁ and Cₚ₂ power ramping counters based on the selected RO. For example, the terminal device 101 may select one of the Cₚ₁ and Cₚ₂ power ramping counters based on whether the selected RO is in the SBFD region (e.g., one of the 801-804 regions shown in FIG. 8).

The followings are examples of different criteria that the terminal device 101 may use to select one of the Cₚ₁ and Cₚ₂ power ramping counters. The terminal device 101, in some embodiments, may select the Cₚ₁ in a case that the selected RO is in the SBFD region, and the terminal device 101 may select the Cₚ₂ in a case that the selected RO is not in the SBFD region. The terminal device 101 may select either one of the Cₚ₁ and Cₚ₂ power ramping counters in a case that the RO is in both the SBFD region and the non-SBFD region.

The terminal device 101, in some embodiments, may select one of the Cₚ₁ and Cₚ₂ power ramping counters based on whether the selected RO is at least partially in the SBFD region. The terminal device 101, in some embodiments, may select Cₚ₁ in a case that the selected RO is at least partially in the SBFD region, and the terminal device 101 may select Cₚ₂ in a case that the selected RO is not even partially in the SBFD region.

The terminal device 101, in some embodiments, may select one of the Cₚ₁ and Cₚ₂ power ramping counters based on whether the selected RO is fully in the SBFD region. For example, the terminal device 101, in some embodiments, may select the Cₚ₁ in a case that the selected RO is fully in the SBFD region, and the terminal device 101 may select the Cₚ₂ in a case that the selected RO is not fully in the SBFD region.

The terminal device 101, in some embodiments, may select Cₚ₁ in a case that the selected RO is both in the SBFD region and the non-SBFD region. The terminal device 101, in some embodiments, may select the Cₚ₂ in a case that the selected RO is both in the SBFD region and the non-SBFD region. The BS 103 may provide an RRC parameter to the terminal device 101 to determine which one of the Cₚ₁ and Cₚ₂ power ramping counters may be selected in a case that the selected RO is both in the SBFD region and the non-SBFD region.

In a case that the terminal device 101 selects one of the Cₚ₁ and Cₚ₂ power ramping counters, the terminal device 101 may calculate the P_{target} by using the selected counter as the Cₚ in Equation (1). The process 900 may use the initial value of the selected power ramping counter for the first transmission of the RA preamble. For example, if the Cₚ₁ and Cₚ₂ power ramping counters were initialized to 1 in block 905, the process 900 may use the value of 1 for the Cₚ in Equation (1). As described below with reference to blocks 935, 950, and 955, if the RA preamble transmission fails, the process 900 may proceed back to block 915 to select another RO and retransmit the RA preamble. In a case of retransmission of the RA preamble, the process 900 may increment the power ramping counter that is selected based on the selected RO before using the Equation (1) to calculate the parameter P_{target}. For example, the terminal device 101 may increment the selected power ramping counter, if the lower layer does not issue suspension of power ramping counter. The terminal device may issue the suspension of power ramping counter if the spatial filter for the PRACH changes.

The process 900 may calculate (at block 925) the Random Access Radio Network Temporary Identifier (RA-RNTI). The RA-RNTI is a bit sequence used to mask the cyclic redundancy check (CRC) bits that are appended to the DCI. The RA-RNTI works as an identifier indicating for which DCI the UE should decode.

The process 900 may transmit (at block 930) the RA preamble at the calculated RA preamble transmission power. For example, according to the terminal device 101 may transmit the RA preamble at the transmission power that is calculated using Equation (2).

The process 900 may make a determination (at block 935) as to whether a Random-Access Response (RAR) with the transmitted preamble index has been received before the end of the RAR window. For example, the terminal device 101 may monitor the RAR which indicates the RA preamble index selected in block 915, described above. In a case that, within the RAR window (e.g., a defined time window), the terminal device 101 does not detect a RAR which indicates the selected RA preamble index, the terminal device 101 may consider the RAR reception as not successful. In this case, the process 900 may proceed to block 950, which is described below.

In a case that the terminal device 101 detects a RAR which indicates the selected RA preamble index, the terminal device 101 may consider the RAR reception as successful. In this case, the process 900 may transmit (at block 940) a message 3 (MSG3) PUSCH transmission. For example, the terminal device 101 may transmit a message PUSCH transmission.

The process 900 may make a determination (at block 945) as to whether the contention resolution is successful. For example, the contention resolution may be achieved by the reception of DL assignments, UL grants, or a PDSCH including a contention resolution identifier. In a case where the contention resolution is successful, the process 900 may determine that random-access has been successfully completed and the process 900 may end. In a case where the contention resolution is not successful, the process 900 may proceed to block 950.

At block 950, the process 900 may determine whether the transmission counter C_{TX} is equal to the configured maximum transmission number. The configured maximum transmission number may be provided by one or more RRC parameters by the BS. In a case that the transmission counter C_{TX} is equal to the configured maximum transmission number, the process 900 may report (at block 960) an RA problem. For example, the terminal device 101 may report “random-access problem” to the higher layers. The process 900 may then end.

In a case that the transmission counter C_{TX} is not equal to the configured maximum transmission number, the process 900 may increment (at block 955) the transmission counter C_{TX}. The process 900 may then proceed to block 915, which was described above.

In the example CBRA procedures described in FIG. 9, once the RA configuration is selected in block 910, the process 900 may repeat the RA preamble transmissions using the same RA configuration until the RA is successfully completed (as described above with reference to block 945) or the RA problem is reported to the higher layers (as described above with reference to block 960.

The specific operations of the process 900 may not be performed in the exact order shown and described. Furthermore, the specific operations described with reference to FIG. 9 may not be performed in one continuous series of operations in some embodiments, and different specific operations may be performed in different embodiments. In addition, one or more steps of the process 900 may be skipped in different embodiments.

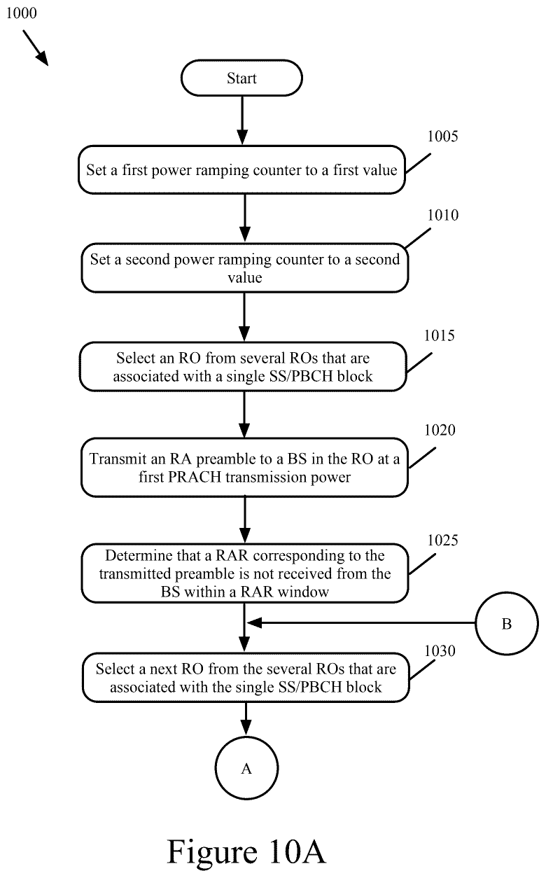

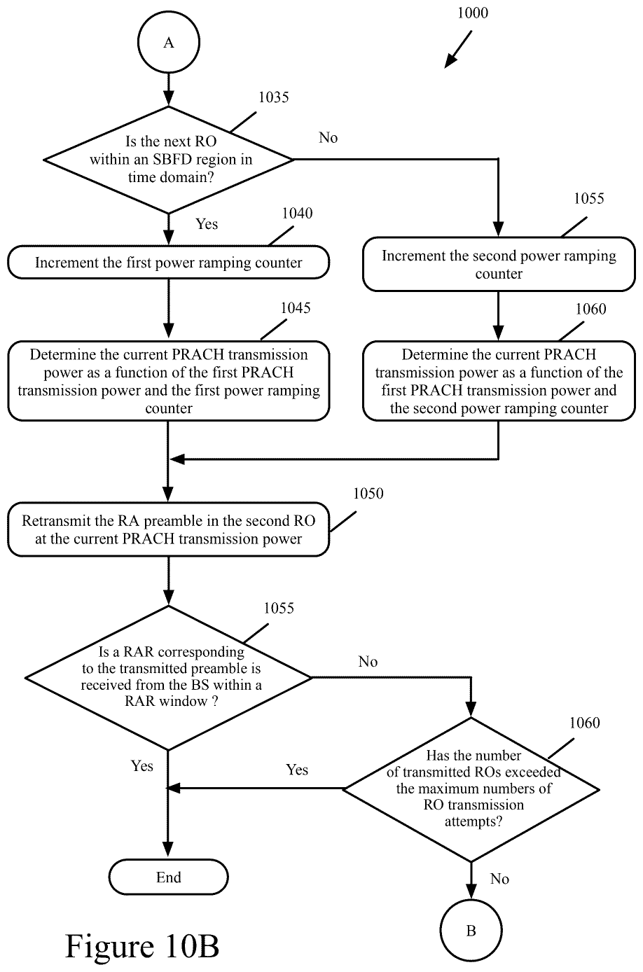

FIGS. 10A-10B illustrate a flowchart of an example method/process 1000 performed by a terminal device to determine the PRACH transmission power using two power ramping counters, according to an example implementation of the present disclosure. The process 1000 may be performed by at least one processor of the terminal device 101, shown in FIGS. 6 and 21.

The process 1000 may set (at block 1005) a first power ramping counter to a first value. For example, the terminal device 101 may set the power ramping counter Cₚ₁ to 1 as a part of the initialization of the RA procedure parameters. The process 1000 may set (at block 1010) a second power ramping counter to a second value. For example, the terminal device 101 may set the power ramping counter Cₚ₂ to 1 as a part of the initialization of the RA procedure parameters.

The process 1000 may select (at block 1015) an RO from several ROs that are associated with a single SS/PBCH block. For example, the terminal device 101 may select an RO that is associated with the single SS/PBCH block in one of the SBFD regions 801-804 or one of the non-SBFD regions 821-824 shown in FIG. 8.

The process 1000 may transmit (at block 1020) an RA preamble to a BS in the RO at a first PRACH transmission power. The first transmission power may, for example, be the P_{PRACH} shown in the Equation (2). The value of the parameter P_{target} in the Equation (2) may be calculated from the Equation (1) by setting the value of Cₚ to 1, resulting in the value of Cₚ-1 to be 0. As described below, in case of a retransmission of the RA preamble, the selected power ramping counter may be incremented in order to calculate a current power transmission power for the RA preamble retransmission. The first PRACH transmission power may be a function of a value associated with a preamble format used to transmit the PRACH and an initial power value received from the BS as an RRC parameter in an RRC message.

The process 1000 may determine (at block 1025) that a RAR corresponding to the transmitted preamble is not received from the BS within a RAR window. The process 1000 may select (at block 1030) a second RO from the several ROs that are associated with the single SS/PBCH block.

The process 1000 may determine (at block 1035) whether the second RO is within an SBFD region in time domain. In a case that the second RO is not within an SBFD region in time domain, the process 1000 may proceed to block 1055, which is described below. In a case that the second RO is within an SBFD region in time domain, the process 1000 may increment (at block 1040) the first power ramping counter. For example, the terminal device 101 may increment the power ramping counter Cₚ₁.

The process 1000 may determine (at block 1045) the current PRACH transmission power as a function of the first PRACH transmission power and the first power ramping counter. The current PRACH transmission power may further be a function of an RSRP received, from the BS, as an RRC parameter. The current PRACH transmission power may further be a function of a power ramping step received, from the BS, as an RRC parameter in an RRC message. The process 1000 may retransmit (at block 1050) the RA preamble in the second RO at the current PRACH transmission power.

The process 1000 may determine (at block 1055) whether a RAR corresponding to the transmitted preamble is received from the BS within a RAR window. In a case that the RAR corresponding to the transmitted preamble is received, the process 1000 may end.

Otherwise, the process 100 may determine (at block 1060) whether the number of transmitted ROs has exceeded the maximum number of RO transmission attempts. In a case that the number of transmitted ROs has exceeded the maximum number of RO transmission attempts, the process 1000 may end. Otherwise, the process 1000 may proceed back to block 1030, which was described above.

In a case that the second RO is not within an SBFD region in time domain, the process 1000 may increment (at block 1055) the second power ramping counter. For example, the terminal device 101 may increment the power ramping counter Cₚ₂. The process 1000 may determine (at block 1060) the current PRACH transmission power as a function of the first PRACH transmission power and the second power ramping counter. The process 1000 may then proceed to block 1050, which was described above.

In a case that a RAR corresponding to the retransmitted RA preamble is received from the BS within the RAR window after the retransmission of the RA preamble in the second RO, the process 1000 may transmit a MSG3 of the RA procedure in response to determining that the RAR corresponding to the transmitted preamble is received from the BS.

In a case that the process 1000 is performing the RA procedure in a CBRA mode, the process 1000 may perform contention resolution by receiving, from the BS, a DL assignment, a UL grant, or a PDSCH that includes a contention resolution identifier.

In a case that a RAR corresponding to the retransmitted RA preamble is not received from the BS within the RAR window after the retransmission of the RA preamble within the second RO at the current PRACH transmission power, the process 1000 may iteratively select another RO from the several ROs, update the current PRACH transmission power based on whether the selected RO is within the SBFD region or outside the SBFD region, and retransmit the RA preamble, in the selected RO, at the updated current transmission power, for a number of times.

The process 1000 may send an RA problem message indicating that the RA procedure has not been performed successfully in a case that no RAR corresponding to a transmitted RA preamble is received from the BS and the number of RA preamble transmissions reaches a maximum number of allowed transmissions. The process 1000 may receive the maximum number of allowed transmissions from the BS as an RRC parameter in an RRC message.

The process 1000 may transmit a MSG3 of the RA procedure in case that a RAR corresponding to a transmitted RA preamble is received from the BS after an RA preamble retransmission.

The process 1000 may stop incrementing the first power ramping counter in a case that the first power ramping counter reaches a corresponding maximum value. The process 1000 may stop incrementing the second power ramping counter in a case that the second power ramping counter reaches a corresponding maximum value.

During the iterative retransmission of the RA preamble, the process 1000 may receive, from a lower layer, a notification requesting the suspension of incrementing the first and second power ramping counters. In response to receiving the notification requesting the suspension, the process 1000 may stop incrementing the first and second power ramping counters.

The process 1000 may select an RA preamble index. In some embodiments, transmitting the RA preamble in the first RO or retransmitting the RA preamble in the second ROs may include transmitting an RA preamble associated with the RA preamble index, and determining that the RAR corresponding to the transmitted preamble is not received from the BS may include determining that a RAR corresponding to the RA preamble index is not received from the BS.

The specific operations of the process 1000 may not be performed in the exact order shown and described. Furthermore, the specific operations described with reference to FIG. 10 may not be performed in one continuous series of operations in some embodiments, and different specific operations may be performed in different embodiments. In addition, one or more steps of the process 1000 may be skipped in different embodiments.

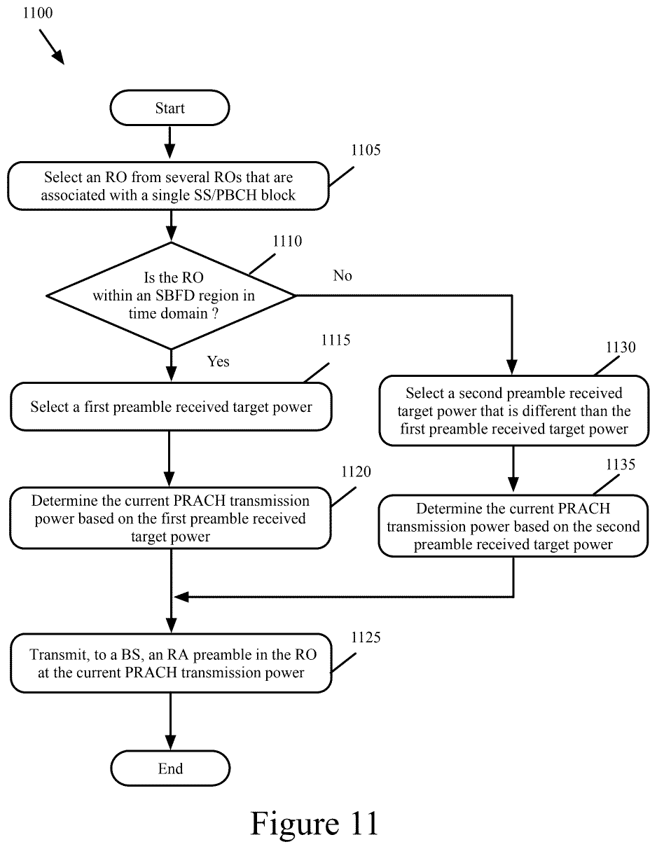

FIG. 11 is a flowchart illustrating an example method/process 1100 performed by a terminal device to determine the PRACH transmission power using two preamble received target powers, according to an example implementation of the present disclosure. The process 1100 may be performed by at least one processor of the terminal device 101, shown in FIGS. 6 and 21.

The process 1100 may select (at block 1105) an RO from several ROs that are associated with a single SS/PBCH block. For example, the terminal device 101 may select an RO that is associated with the single SS/PBCH block in one of the SBFD regions 801-804 or one of the non-SBFD regions 821-824 shown in FIG. 8.

The process 1100 may make a determination (at block 1110) as to whether the RO is within an SBFD region in time domain. In a case that the second RO is not within an SBFD region in time domain, the process 1100 may proceed to block 1130, which is described below.

In a case that the second RO is within an SBFD region in time domain, the process 1100 may select (at block 1115) a first preamble received target power. For example, the process may select the p_{configured,first} configured preamble received target power to use as the p_{configured}.

The process 1100 may determine (at block 1120) the current PRACH transmission power based on the first preamble received target power. For example, the current PRACH transmission power may be the P_{PRACH} shown in the Equation (2). The value of the parameter P_{target} in the Equation (2) may be calculated from the Equation (1) by setting the value of p_{configured,} to p_{configured,first}. The process 1100 may transmit (at block 1125), to a BS, an RA preamble in the RO at the current PRACH transmission power. The process 1100 may then end.

In a case that the second RO is not within an SBFD region in time domain, the process 1100 may select (at block 1130) a second preamble received target power. For example, the process may select the p_{configured,second} configured preamble received target power to use as the p_{configured}.

The process 1100 may determine (at block 1135) the current PRACH transmission power based on the second preamble received target power. For example, the current PRACH transmission power may be the P_{PRACH} shown in the Equation (2). The value of the parameter P_{target} in the Equation (2) may be calculated from the Equation (1) by setting the value of p_{configured,} to p_{configured,second}. The process 1100 may then proceed to block 1125, which was described above.

In a case that the RO is partially with the SBFD region, the process 1100 may select one of the first or second preamble received target powers and may determine the current PRACH transmission power based on the selected preamble received target power. In some embodiments, the first or second preamble received target powers may be selected based on an RRC parameter received from the BS.

In a case that the RO is partially within the SBFD region in the time domain, the process 1100 may select the first preamble received target power and may determine the current PRACH transmission power based on the first preamble received target power. In a case that the RO is partially outside the SBFD region in the time domain, the process 1100 may select the second preamble received target power and may determine the current PRACH transmission power based on the second preamble received target power. The process 1100 may receive the first and second preamble received target powers from the BS as RRC parameters.

The process 1100, in some embodiments, may determine that an RAR corresponding to the transmitted preamble is not received from the BS within a RAR window. In response, the process 1100 may select a second RO from the several ROs associated with the single SS/PBCH block. The process 1100 may then determine whether the second RO is within an SBFD region in the time domain. In a case that the second RO is within the SBFD region in the time domain, the process 1100 may select a first preamble power ramping step. For example, the process 1100 may select the p_{step,first}. The process 1100 may then update the current PRACH transmission power based on the first preamble power ramping step. For example, the process 1100 may update the current PRACH transmission power by using the p_{step,first} as the power ramping step, pₛₜₑₚ, in Equation (1).

In a case that the second RO is not within the SBFD region in the time domain, the process 1100 may select a second preamble power ramping step. For example, the process 1100 may select the p_{step,second}. The process 1100 may then update the current PRACH transmission power based on the second preamble power ramping step. For example, the process 1100 may update the current PRACH transmission power by using the p_{step,second} as the power ramping step, pₛₜₑₚ, in Equation (1). The process 1100 may retransmit the RA preamble in the second RO at the current PRACH transmission power.

In a case that the second RO is partially within the SBFD region in the time domain, the process 1100 may select one of the first or second preamble power ramping steps and may update the current PRACH transmission power based on the selected preamble power ramping step. In some embodiments, selecting one of the first or second preamble power ramping steps may be based on RRC parameters that are received from the BS.

In a case that the second RO is partially outside the SBFD region in the time domain, the process 1100 may select the second preamble power ramping step and may update the current PRACH transmission power based on the second preamble power ramping step.

The process 1100, in some embodiments, may set a first power ramping counter. For example, the terminal device 101 may set the power ramping counter Cₚ₁ to 1 as a part of the initialization of the RA procedure parameters. The process 1000 may set a second power ramping counter to a second value. For example, the terminal device 101 may set the power ramping counter Cₚ₂ to 1 as a part of the initialization of the RA procedure parameters.

In a case that the second RO is within the SBFD region in the time domain, the process 1100 may increment the first power ramping counter and may update the current PRACH transmission power further based on the first power ramping counter. In a case that the second RO is not within the SBFD region in the time domain, the process 1100 may increment the second power ramping counter and may determine the current PRACH transmission power further based on the second power ramping counter.

The process 1100, in some embodiments, may determine that a RAR corresponding to the retransmitted RA preamble is not received from the BS within the RAR window after the retransmission of the RA preamble in the second RO at the current PRACH transmission power. The process 1100 may iteratively select another RO from the plurality of ROs, update the current PRACH transmission power based on whether the selected RO is within the SBFD region or outside the SBFD region in the time domain, and retransmit the RA preamble, in the selected RO, at the updated current transmission power, for a number of times.

The specific operations of the process 1100 may not be performed in the exact order shown and described. Furthermore, the specific operations described with reference to FIG. 11 may not be performed in one continuous series of operations in some embodiments, and different specific operations may be performed in different embodiments. In addition, one or more steps of the process 1100 may be skipped in different embodiments.

### Backoff Indicator

As described above, when a terminal device 101 initiates a RA procedure, the terminal device transmits an RA preamble on PRACH to the BS 103. The subsequent steps depend on whether the preamble was detected by the BS 103 and whether the BS 103 wants to allocate resources to the terminal device 101 for uplink communication.

In a case that the BS 103 detects the PRACH and has resource to allocate to the terminal device 101 for uplink communication, the BS 103 may send a RAR message corresponding to the RA preamble. The RAR may include a UL grant for the terminal device 101 to send a Msg3.

In a case that the BS 103 does not detect the PRACH, the terminal device 101 does not receive a RAR corresponding to the RA preamble. The terminal device 101 may assume failure and may follow its own retransmission rules (e.g., retry transmitting the PRACH for a number of time).

In some case, however, the BS 103 may be receiving RA request from many terminal devices but the BS 103 many not want to allocate resources to some of the terminal devices (e.g., the BS 103 is serving too many other terminal devices and may want some of the terminal devices to wait and retry the PRACH). In this case, the BS 103 may send a RAR that includes a backoff indicator (BI) to some of the terminal devices. For example, the BS 103 may send the RAR to a group of terminal devices instructing them to retry the PRACH after a delay.

In such cases where the BS wants to control access to PRACH resources by terminal devices, the base station device 103 may transmit a RAR including a Sub Protocol Data Unit (subPDU) with the BI. The value of the BI indicated via the subPDU may be used by the terminal device 101 to calculate a PREAMBLE_BACKOFF. The PREAMBLE_BACKOFF may be calculated by the indicated value multiplied by a scaling factor.

The terminal device 101 may select a random backoff time according to a uniform distribution between 0 and the PREAMBLE_BACKOFF. The terminal device 101 may wait to transmit another PRACH until the random backoff time expires. The random backoff time may be expressed in milliseconds.

The terminal devices in prior art use the same scaling factor for calculating the backoff time regardless of whether the PRACH is being transmitted in the SBFD region or the non-SBFD region. However, the network may have different load and different congestion for the SBFD and the non-SBFD regions. Some of the present embodiments provide a method of using different scaling factors to calculate the backoff time when the PRACH is transmitted in the SBFD and non-SBFD regions. Using different delays for retransmission of the PRACH in the SBFD and non-SBFD regions provides the technical advantage of adjusting the backoff time based on the congestion of each particular region. The adaptive retransmission delay of the PRACH based on the regions provides flexibility of separately controlling the congestion and communication traffic in each of the SBFD and non-SBFD regions.

In some embodiments, for each PRACH configuration, different scaling factors may be provided via respective RRC parameters for respective regions. Once the terminal device terminal device selects either the SBFD region or the non-SBFD region for a PRACH transmission, the terminal device may use the scaling factor for the selected region to calculate the backoff time.

The terminal device may use different criteria for selecting a scaling factor based on the region. In some embodiments, the terminal device 101 may select the scaling factor based on the region where the last PRACH was transmitted. For example, after the terminal device 101 receives the RAR including the subPDU, the terminal device 101 may select the scaling factor based on the region in which the last PRACH transmission has been performed. For example, the terminal device 101 may select the scaling factor corresponding to the SBFD region if the last PRACH transmission has been performed in the SBFD region. On the other hand, the terminal device 101 may select the scaling factor corresponding to the non-SBFD region if the last PRACH transmission has been performed in the non-SBFD region.

In some embodiments, the terminal device 101 may select the scaling factor based on the region where the RAR including the subPDU is received. For example, if the RAR including the subPDU is received in the SBFD region, the terminal device 101 may select the scaling factor for the SBFD region. On the other hand, if the RAR including the subPDU is received in the non-SBFD region, the terminal device 101 may select the scaling factor for the non-SBFD region.

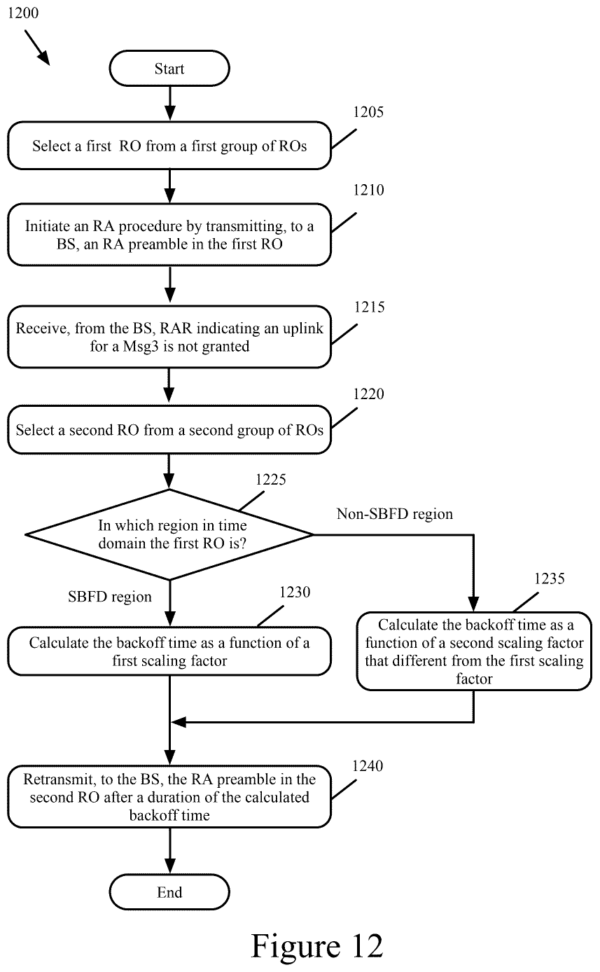

FIG. 12 illustrates a flowchart of an example method/process 1200 of determining the backoff time for transmitting a PRACH based on which region the last RO is transmitted, according to an example implementation of the present disclosure. The process 1200 may be performed by at least one processor of the terminal device 101, shown in FIGS. 6 and 9.

The process 1200 may select (at block 1205) a first RO from a first group of ROs. For example, the process 1200 may select an RO in one of the regions 801-804 or 821-824 shown in FIG. 8. The ROs may be associated with a SS/PBCH block.

The process 1200 may initiate (at block 1210) an RA procedure by transmitting, to a BS, an RA preamble in the first RO. For example, the process 1200 may transmit the RA preamble on a PRACH.

The process 1200 may receive (at block 1215), from the BS, RAR indicating an uplink for a Msg3 is not granted. The RAR, in some embodiments, may include a BI. In some embodiments, the process 1200 may receive the RAR message as a group message that the BS sends to several terminal devices. For example, the BS may broadcast the RAR message.

The process 1200 may select (at block 1220) a second RO from a second group of ROs. For example, the process 1200 may select an RO in one of the regions 801-804 or 821-824 shown in FIG. 8. The ROs may be associated with an SS/PBCH block. In some embodiments, the RAR may identify the second RO to be within the SBFD region or the non-SBFD region for the retransmission of the RA preamble. In these embodiments, the process 1200 may select the second RO in the region indicated by the RAR.

The process 1200 may determine (at block 1225) in which region in time domain the first RO is selected. For example, the process 1200 may determine whether the RO is in the SBFD regions 801-804 or the non-SBFD region 821-824 shown in FIG. 8.

In a case that the first RO is in the SBFD region, the process 1200 may calculate (at block 1230) the backoff time as a function of a first scaling factor. For example, the process 1200, in some embodiments, may calculate a preamble backoff value by multiplying the BI received in the RAR by the first scaling factor. The process 1200 may select the backoff time as a random value between 0 and the preamble backoff value. The process 1200 may then proceed to block 1240, which is described below.

In a case that the first RO is in the non-SBFD region, the process 1200 may calculate (at block 1235) the backoff time as a function of a second scaling factor that different from the first scaling factor. For example, the process 1200, in some embodiments, may calculate a preamble backoff value by multiplying the BI received in the RAR by the second scaling factor. The process 1200 may select the backoff time as a random value between 0 and the preamble backoff value.

The process 1200 may retransmit (at block 1240), to the BS, the RA preamble in the second RO after a duration of the calculated backoff time. For example, after the expiration of the timer that is set to the value of backoff time, the process 1200 may transmit the RA preamble on the PRACH. The process 1200 may then end.

The process 1200, in some embodiments, may receive the first and second scaling factors via one or more RRC messages. For example, the process 1200 may receive, from the BS, the first scaling factor, as a first RRC parameter associated with the SBFD region. The process 1200 may receive, from the BS, the second scaling factor, as a second RRC parameter associated with the non-SBFD region.

In a case that the BS decides to provide an uplink grant, the process 1200 may receive, from the BS, a second RAR corresponding to the retransmitted RA preamble within the RAR time window. The second RAR may include an uplink grant for a Msg3 of the RA procedure. The process 1200 may then transmit, to the BS, the Msg3 in response to receiving the second RAR.

The process 1200 may repeat the retransmission of the RA preamble several times. For example, for a number of times and before reaching a maximum number of RA preamble transmission attempts, the process 1200 may perform the followings. Receive, from the BS, an RAR indicating an uplink for a Msg3 is not granted. Select a next RO for transmission of the RA preamble. In a case that an immediately transmitted RO is within the SBFD region in the time domain, calculate the backoff time as a function of the first scaling factor. In a case that the immediately transmitted RO is within the non-SBFD region in the time domain. Calculate the backoff time as a function of the second scaling factor. Retransmit, to the BS, the RA preamble in the next RO after a duration of the calculated backoff time.

The process 1200 may repeat the loop for the retransmission of the RA preamble until either the maximum number of RA preamble transmission attempts is reach or a RAR is received that indicates the uplink for a Msg3 is granted.

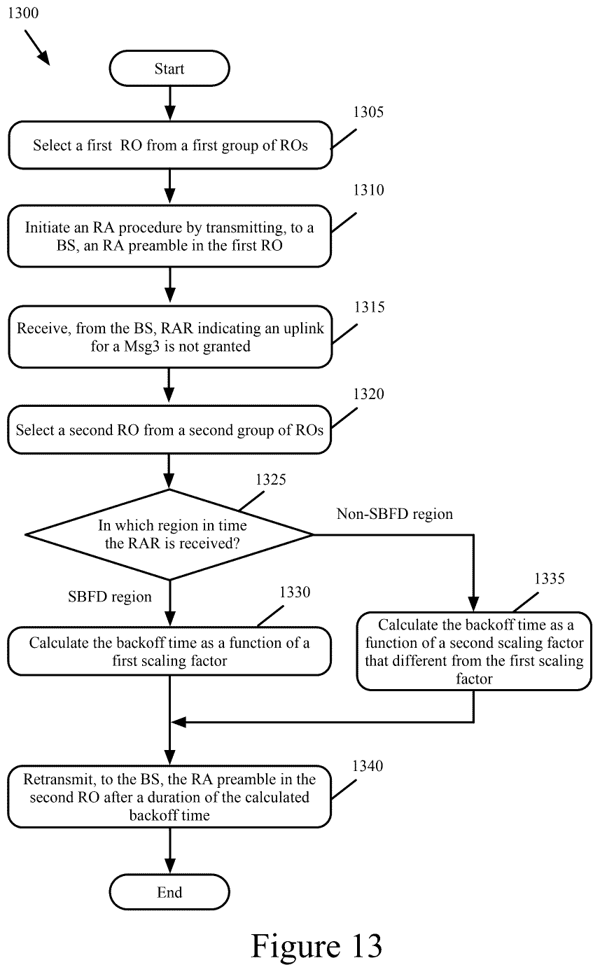

FIG. 13 illustrates a flowchart of an example method/process 1300 of determining the backoff time for transmitting a PRACH based on the region in which the last RAR is received, according to an example implementation of the present disclosure. The process 1300 may be performed by at least one processor of the terminal device 101, shown in FIG. 6. For example, the processor of the terminal device 101 may perform the process 1200 in the MAC layer processing unit (the MAC entity) 15 and the wireless transmission and reception unit (the physical layer unit) 10.

The process 1300 may select (at block 1305) a first RO from a first group of ROs. For example, the process 1300 may select an RO in one of the regions 801-804 or 821-824 shown in FIG. 8. The ROs may be associated with a SS/PBCH block.

The process 1300 may initiate (at block 1310) an RA procedure by transmitting, to a BS, an RA preamble in the first RO. For example, the process 1300 may transmit the RA preamble on the PRACH.

The process 1300 may receive (at block 1315), from the BS, RAR indicating an uplink for a Msg3 is not granted. The RAR, in some embodiments, may include a BI. In some embodiments, the process 1300 may receive the RAR message as a group message that the BS sends to several terminal devices. For example, the BS may broadcast the RAR message.

The process 1300 may select (at block 1320) a second RO from a second group of ROs. For example, the process 1300 may select an RO in one of the regions 801-804 or 821-824 shown in FIG. 8. The ROs may be associated with the SS/PBCH block. In some embodiments, the RAR may identify the second RO to be within the SBFD region or the non-SBFD region for the retransmission of the RA preamble. In these embodiments, the process 1200 may select the second RO in the region indicated by the RAR.

The process 1300 may determine (at block 1325) in which region in time domain the RAR is received. For example, the process 1300 may determine whether the RAR was received in the SBFD regions 801-804 or the non-SBFD region 821-824 shown in FIG. 8.

In a case that the RAR is received in the SBFD region, the process 1200 may calculate (at block 1330) the backoff time as a function of a first scaling factor. For example, the process 1300, in some embodiments, may calculate a preamble backoff value by multiplying the BI received in the RAR by the first scaling factor. The process 1300 may select the backoff time as a random value between 0 and the preamble backoff value. The process 1300 may then proceed to block 1340, which is described below.

In a case that the RAR is received in the non-SBFD region, the process 1300 may calculate (at block 1335) the backoff time as a function of a second scaling factor that different from the first scaling factor. For example, the process 1300, in some embodiments, may calculate a preamble backoff value by multiplying the BI received in the RAR by the second scaling factor. The process 1300 may select the backoff time as a random value between 0 and the preamble backoff value.

The process 1300 may retransmit (at block 1340), to the BS, the RA preamble in the second RO after a duration of the calculated backoff time. For example, after the expiration of the timer that is set to the value of backoff time, the process 1300 may transmit the RA preamble on the PRACH. The process 1300 may then end.

The process 1300, in some embodiments, may receive the first and second scaling factors via one or more RRC messages. For example, the process 1300 may receive, from the BS, the first scaling factor, as a first RRC parameter associated with the SBFD region. The process 1300 may receive, from the BS, the second scaling factor, as a second RRC parameter associated with the non-SBFD region.

In a case that the BS decides to provide an uplink grant, the process 1300 may receive, from the BS, a second RAR corresponding to the retransmitted RA preamble within the RAR time window. The second RAR may include an uplink grant for a Msg3 of the RA procedure. The process 1300 may then transmit, to the BS, the Msg3 in response to receiving the second RAR.

The process 1300 may repeat the retransmission of the RA preamble several times. For example, for a number of times and before reaching a maximum number of RA preamble transmission attempts, the process 1300 may perform the followings. Receive, from the BS, an RAR indicating an uplink for a Msg3 is not granted. Select a next RO for transmission of the RA preamble. In a case that the last RAR is received within the SBFD region in the time domain, calculate the backoff time as a function of the first scaling factor. In a case that the last RAR is received within the non-SBFD region in the time domain, calculate the backoff time as a function of the second scaling factor. Retransmit, to the BS, the RA preamble in the next RO after a duration of the calculated backoff time.

The process 1300 may repeat the loop for the retransmission of the RA preamble until either the maximum number of RA preamble transmission attempts is reach or a RAR is received that indicates the uplink for a Msg3 is granted.

### Message 3 PUSCH Transmission Power Control

In controlling Msg3 PUSCH, the terminal device may calculate transmission power P_{Msg3} as shown in Equation (3).

$${P}_{Msg3} = min ( {P}_{CMAX} , 10 {log}_{10} ( {2}^{u} \cdot {M}_{RB}^{PUSCH} ( i ) ) + α ( j ) \cdot PL + Δ + f ) \qquad Equation ( 3 )$$

Here, u denotes the subcarrier-spacing configuration of the Msg3 PUSCH, M_{RB}^{PUSCH} denotes the number of RBs allocated for the Msg3 PUSCH, a denotes a scaling factor of PL, Δ denotes a power adjustment factor, PL is the path loss in the communication path and f denotes a closed-loop power controller. Δ may be used to adjust the transmit power to compensate losses due to e.g., different modulation schemes.

For Msg3 PUSCH, f may be calculated as shown in Equation (4).

$$f = {Δ}_{rampup} + {δ}_{msg2} \qquad Equation ( 4 )$$

Here, Δᵣₐₘₚᵤₚ denotes the value of PREAMBLE_RECEIVED_TARGET_POWER (referred to as P_{target}), and δ_{msg2} denotes the power adjustment value indicated by the TPC command in the RAR grant for the Msg3 PUSCH.

In a case that two power ramping counters Cₚ₁ and Cₚ₂ are maintained, the terminal device 101 may be required to select one counter to calculate transmit power of Msg3 PUSCH.

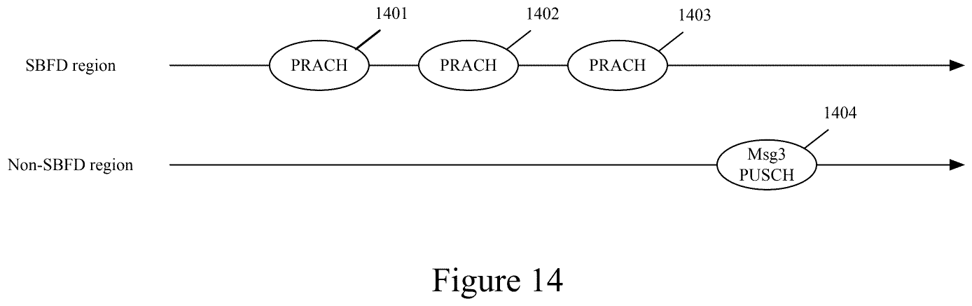

FIG. 14 is an example flow diagram of the random-access procedure, according to an example implementation of the present disclosure. As shown in the example of FIG. 14, the terminal device 101 may transmit the PRACH in the occasions 1401, 1402, and 1403 in the SBFD region.

The terminal device 101 may transmit the PRACH in the occasion 1401. The terminal device 101 may not receive a RAR with the transmitted preamble index before the end of the RAR window after the PRACH transmission in the occasion 1401. Therefore, the terminal device 101 may increment the power ramping counter Cₚ₁ to 2, and may transmit the PRACH in the occasion 1402. The terminal device 101 may not receive a RAR with the transmitted preamble index before the end of the RAR window after the PRACH transmission in the occasion 1402. Therefore, the terminal device 101 may increment the power ramping counter Cₚ₁ to 3, and may transmit the PRACH in the occasion 1403.

The terminal device 101 may receive a RAR with the transmitted preamble index before the end of the RAR window after the PRACH transmission in the occasion 1403. Therefore, the terminal device 101 may not increment the power ramping counter Cₚ₁. It should be noted that even though example of FIG. 14 shows the PRACH transmissions in the SBFD region and the Msg3 PUSCH transmission in the non-SBFD region, the PRACH transmissions may be in the non-SBFD region and the Msg3 PUSCH transmission may be in the SBFD region. In other examples, the PRACH transmissions and the PUSCH transmission may be in the same region (e.g., all transmissions may be either in the SBFD region or in the non-SBDF region).

The RAR may include a RAR grant which schedules a Msg3 PUSCH transmission. In the example of FIG. 14, the Msg3 PUSCH 1404 transmission may be scheduled in the non-SBFD region. In this case, the power ramping counter Cₚ₁ may not optimally control the power of the PUSCH transmission because it does not reflect the power ramp-up in the non-SBFD region. In any transmission system, the transmission power by the UE should be carefully controlled not to interfere with other serving cells, the neighbor cells.

In the prior art, irrespective of the region, the UE may apply the previous power ramp up status. Some embodiments provide a method of controlling the Msg3 PUSCH transmission power based on whether the PRACH transmissions and the scheduled PUSCH transmissions are in the same or in different regions. Using different PUSCH transmission power in the SBFD and non-SBFD regions provides the technical advantage of providing optimal communication performance and minimizing interference with other neighboring cells.

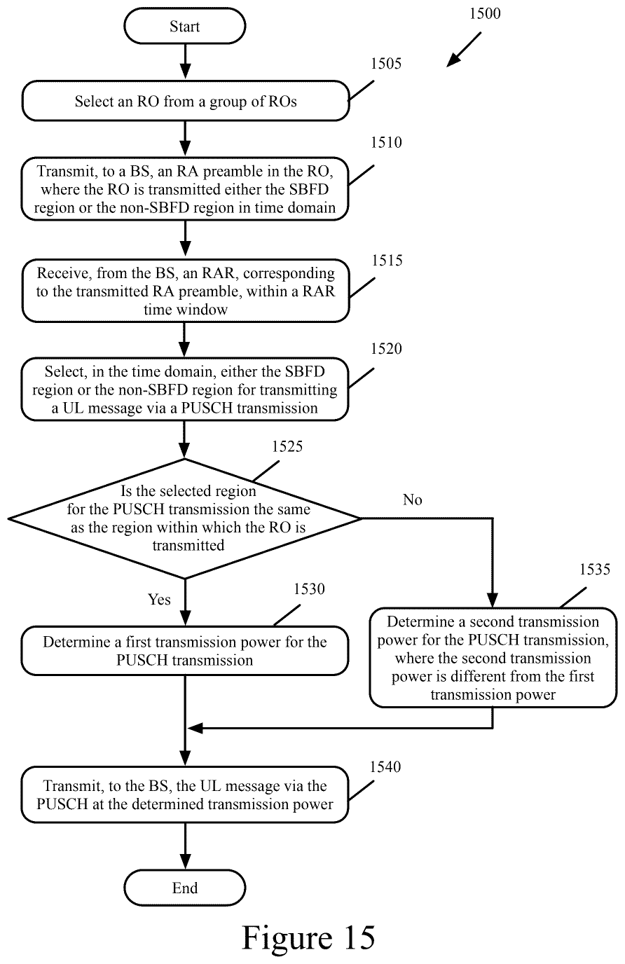

FIG. 15 illustrates a flowchart of an example method/process 1500 of determining the PUSCH transmission power during the random access procedure, according to an example implementation of the present disclosure. The process 1500 may be performed by at least one processor of the terminal device 101, shown in FIGS. 6 and 21.

The process 1500 may select (at block 1505) an RO from a group of ROs. For example, the process 1500 may select an RO in one of the regions 801-804 or 821-824 shown in FIG. 8. The ROs may be associated with a SS/PBCH block.

The process 1500 may transmit (at block 1510), to a BS, an RA preamble in the RO, where the RO is transmitted either the SBFD region or the non-SBFD region in time domain. For example, if the selected RO is in one of the regions 801-804, then the process 1500 may transmit the RO in the SBFD region. On the other hand, if the selected RO is in one of the regions 821-824, then the process 1500 may transmit the RO in the non-SBFD region.

The process 1500 may receive (at block 1515), from the BS, an RAR, corresponding to the transmitted RA preamble, within a RAR time window. For example, the process 1300 may receive a RAR that grants the uplink for a Msg3.

The process 1500 may select (at block 1520), in the time domain, either the SBFD region or the non-SBFD region for transmitting a UL message via a PUSCH transmission. For example, the process 1500 may select one of the SBFD regions 801-804 or one of the non-SBFD regions 821-824 for transmitting the PUSCH.

The process 1500 may decide (at block 1525) whether the selected region for the PUSCH transmission is the same as the region within which the RO is transmitted. In a case that the selected region for the PUSCH transmission is the same as the region within which the RO is transmitted, the process 1500 may determine (at block 1530) a first transmission power for the PUSCH transmission.

In a case that the selected region for the PUSCH transmission is not the same as the region within which the RO is transmitted, the process 1500 may determine (at block 1535) a second transmission power for the PUSCH transmission, where the second transmission power is different from the first transmission power.

The process 1500 may transmit (at block 1535), to the BS, the UL message via the PUSCH at the determined transmission power. The process 1500 may then end.

Different embodiments may use different criteria for selecting the first and second transmission powers. Several alternatives are described in the following sections. It should be noted that these alternatives are not mutually exclusive, therefore, some embodiments may combine several of these alternatives to determine the power transmission for the PUSCH.

### First Alternative—Different Power Ramp-Up Counters are Applied to Each Region

The process 1500 may select one power ramping counter from the Cₚ₁ and Cₚ₂ counter based on whether the Msg3 PUSCH is scheduled in the SBFD region. The process 1500, in some embodiments, may determine (at block 1525) in which region the Msg3 PUSCH is scheduled. Based on the determined region, the process 1500 may determine a power ramping counter.

For example, in a case that the process 1500 determines (at block 1525) that the Msg3 PUSCH is scheduled in the SBFD region, the terminal device 101 may select (at block 1530) Cₚ₁ to calculate f in Equation (4) for the transmit power of the Msg3 PUSCH. The process 1500 may then use the value of f to calculate the transmission power of the PUSCH, P_{Msg3}, using the Equation (3).

In a case that the process 1500 determines (at block 1525) that the Msg3 PUSCH is scheduled in the non-SBFD region, the process 1500 may select (at block 1535) Cₚ₂ to calculate f in the transmit power of the Msg3 PUSCH. The process 1500 may then use the value of f to calculate the transmission power of the PUSCH, P_{Msg3}, using the Equation (3).

### Second Alternative—Apply Different Delta Power Offset for Different Regions

The process 1500, in some embodiments, may apply a delta power offset to calculate the PRUCH transmission power for different regions. The process 1500, may use two different alternative.

### Alternative 2a: Using of RRC Configured Delta Power Offset

The process 1500, in some embodiments, may be provided with a delta power offset Δ_{non-SBFD}. The delta power offset may be provided, for example, via an RRC parameter. The process 1500 may apply the delta power offset based on comparison of the first region where the last PRACH transmission is performed before the Msg3 PUSCH transmission and the second region of the Msg3 PUSCH transmission. For example, in a case where the process 1500 determines that the first region is the SBFD region and the second region is the non-SBFD region, process 1500 may calculate (at block 1535) the PUSCH transmission power P_{Msg3} as shown in Equation (5).

$${P}_{Msg3} = min ( {P}_{CMAX} , \\ 10 {log}_{10} ( {2}^{u} \cdot {M}_{RB}^{PUSCH} ( i ) ) + α ( j ) \cdot PL + Δ + f + {Δ}_{non - SBFD} ) \qquad Equation ( 5 )$$

On the other hand, in a case where the process 1500 determines that the first region is the same as the second region (e.g., both regions are non-SBFD), the process 1500 may determine (at block 1535) the PUSCH transmission power P_{Msg3} as shown in Equation (3).

In a case where the on the other hand, determines that the first region is the non-SBFD region and the second region is the SBFD region, process 1500 may determine (at block 1530) P_{Msg3} as shown in Equation (6).

$${P}_{Msg3} = min ( {P}_{CMAX} , \\ 10 {log}_{10} ( {2}^{u} \cdot {M}_{RB}^{PUSCH} ( i ) ) + α ( j ) \cdot PL + Δ + f - {Δ}_{non - SBFD} ) \qquad Equation ( 6 )$$

On the other hand, in a case where the process 1500 determines that the first region is the same as the second region (e.g., both regions are SBFD), the process 1500 may determine (at block 1535) the PUSCH transmission power P_{Msg3} as shown in Equation (3).

In the examples of Equations (5) and (6), the same delta power offset Δ_{non-SBFD} is used. In Equation (5) the delta power offset Δ_{non-SBFD} is added to the value of f, while in Equation (6) the delta power offset Δ_{non-SBFD} is subtracted from the value of f. In other embodiments, a different delta power offset may be provided for each region. The delta power offset(s), in some embodiments, may be provided by the BS via an RRC parameter.

### Alternative 2b: Different TPC Command Tables in Respective Cases

In some embodiments, different TPC command tables may be provided for calculating the transmission power of the PUSCH for different regions. The TPC commands may be utilized to adjust the uplink transmission power of the terminal device to ensure efficient communication and manage interference. The TPC commands may be conveyed, for example, through DCI formats, such as DCI formats 2_2 and 2_3, which are designed to transmit TPC commands for the PUSCH, PUCCH, and SRS. The TPC commands within these DCI formats are typically represented by a set of bits that correspond to specific power adjustment values. For instance, a 2-bit TPC command may indicate different power adjustments, such as −6 dB, −4 dB, −2 dB, or 0 dB, allowing the network to fine-tune the terminal device's transmission power based on current conditions. The TPC command tables may provide the mapping between the TPC command bits and their corresponding power adjustment values. These mappings may be used by the terminal device to interpret the TPC commands correctly and adjust its transmission power accordingly.

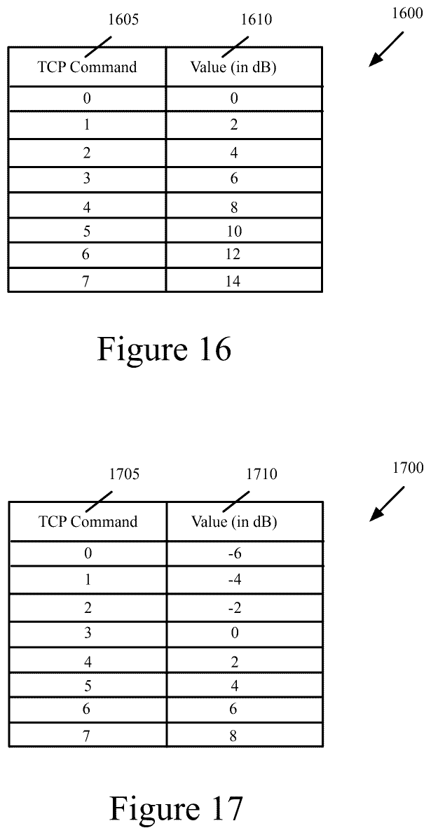

The process 1500, in some embodiments, may apply different TPC command tables based on the comparison of the region where the last PRACH transmission is performed before the Msg3 PUSCH transmission and the region of the Msg3 PUSCH transmission. FIGS. 16 and 17 illustrate two TPC tables that may be used for determining the PUSCH transmission power, according to an example implementation of the present disclosure.

As an example, in a case where the process 1500 determines that the first region is the SBFD region and the second region is the non-SBFD region, the table 1600 may be used to determine (at block 1535) the transmission power of the PUSCH. As shown in FIG. 16, the table 1600 may include the values {0, 2, 4, 6, 8, 10, 12, 14} in value field 1610. Each entry in the first table is associated with the code point “000,” “001,” “010,” “011,” “100,” “101,” “110,” and “111” of the TPC command field 1605 (the table shows the decimal values of the code points. The terminal device may retrieve the value field 1610 that corresponds to the value provided in the TCP command from the table 1600, and may insert the value in Equation (4) as the value of the power adjustment value, δ_{msg2}.

On the other hand, in a case where the terminal process 1500 determines that the first region is the same as the second region, the table 1700 may be used to determine (at block 1530) the transmission power of the PUSCH. For example, the table 1700 may include values {−6, −4, −2, 0, 2, 4, 6, 8} in value field 1710. Each entry in the table 1700 may be associated with the code point “000,” “001,” “010,” “011,” “100,” “101,” “110,” and “111” of the TPC command field 1705 (the table shows the decimal values of the code points. The terminal device may retrieve the value field 1710 that corresponds to the value provided in the TCP command from the table 1700, and may insert the value in Equation (4) as the value of the power adjustment value, δ_{msg2}.

### Alternative 3: Configured Initial Value of the Power Ramping Counter

In some embodiments, an initial value may be configurable for each power ramping counter. The initial value for the power ramping counter Cₚ₁, in some embodiments, may be provided via an RRC parameter. In a case that the initial value is provided, the process 1500 may use the initial value of Cₚ₁ to determine (at block 1535) the transmission power of the PUSCH using Equation (1).

The initial value for the power ramping counter Cₚ₂, in some embodiments, may be provided via an RRC parameter. In a case that the initial value is provided, the process 1500 may use the initial value of Cₚ₂ to determine (at block 1530) the transmission power of the PUSCH using Equation (1).

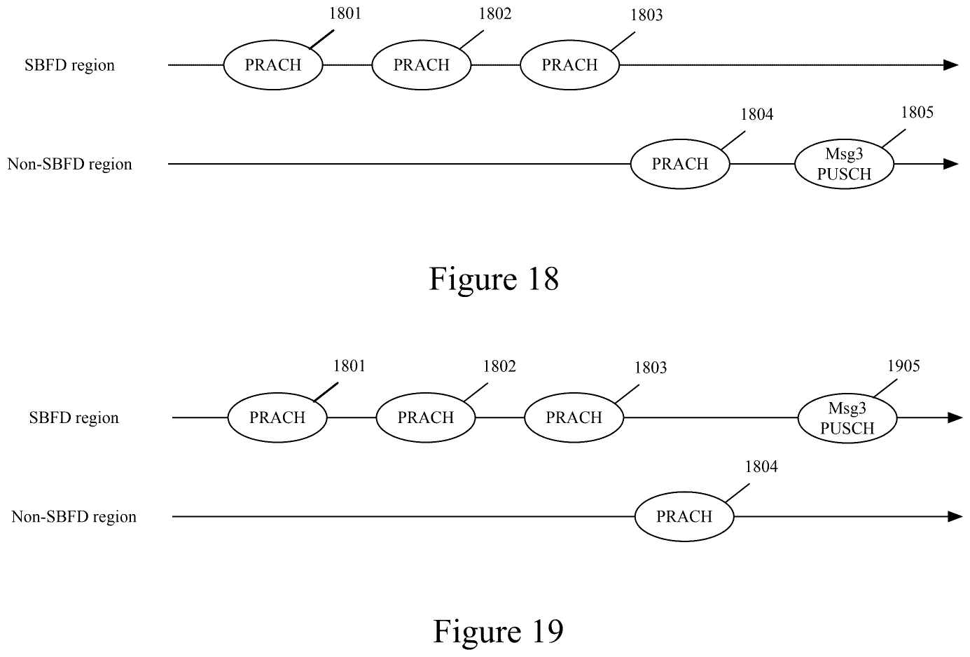

In some embodiments, the number of PRACH transmissions in one of the regions may reach a maximum value and the terminal device may continue retransmission of the PRACH occasions in the other region. FIGS. 18 and 19 are example flow diagrams of the random-access procedure, where the PRACH transmission may be performed in two different regions, according to an example implementation of the present disclosure. As shown in the example of FIG. 18, the terminal device 101 may transmit the PRACH in the occasions 1801, 1802, and 1803 in the SBFD region. The terminal device may maintain a transmission counter for each of the SBFD and non-SBFD regions. The transmission counters may be initialized to 0 at the beginning of the RA procedure. The terminal device 101, in some embodiments, may maintain different power ramping counters for different regions. For example, the terminal device 101 may maintain the power counter Cₚ₁ for the SBFD region, and the power counter Cₚ₂ for the non-SBFD region.

The terminal device 101 may transmit the PRACH in the occasion 1801. The terminal device 101 may not receive a RAR with the transmitted preamble index before the end of the RAR window after the PRACH transmission in the occasion 1801. Therefore, the terminal device 101 may increment the transmission counter for the SBFD region to 1, may increment the power ramping counter Cₚ₁ to 2, and may transmit the PRACH in the occasion 1802.

The terminal device 101 may not receive a RAR with the transmitted preamble index before the end of the RAR window after the PRACH transmission in the occasion 1802. Therefore, the terminal device may increment the transmission counter for the SBFD region to 2, may increment the power ramping counter Cₚ₁ to 3, and transmit the PRACH in the occasion 1803.

The terminal device 101 may not receive a RAR with the transmitted preamble index before the end of the RAR window after the PRACH transmission in the occasion 1803. The terminal device may increment the transmission counter for the SBFD region to 3. The terminal device may determine that the maximum number of transmission for the PRACH in the SBFD region has reached. therefore, the terminal device may transmit the PRACH in the occasion 1804 in the non-SBFD region, may increment the transmission counter for the non-SBFD region to 1, and may increment the power ramping counter Cₚ₂ to 2.

The terminal device 101 may receive a RAR with the transmitted preamble index before the end of the RAR window after the PRACH transmission in the occasion 1804. Therefore, the terminal device may not increment the power ramping counter Cₚ₂. The RAR may include a RAR grant which schedules a Msg3 PUSCH transmission. The Msg3 PUSCH transmission may be scheduled in the non-SBFD region. The example of FIG. 19 is similar to the Example of FIG. 18, except that the Msg3 PUSCH transmission is performed in a different region than the last PRACH occasion.

It should be noted that in FIGS. 18 and 19, the PRACH occasions 1801-1803 and the Msg3 PUSCH 1905 are transmitted in the SBD region and the PRACH occasions 1804 and the Msg3 PUSCH 1805 are transmitted in the non-SBFD region. In other examples, the PRACH occasions 1801-1803 and the Msg3 PUSCH 1905 may be transmitted in the non-SBD region and the PRACH occasions 1804 and the Msg3 PUSCH 1805 are transmitted in the SBFD region.

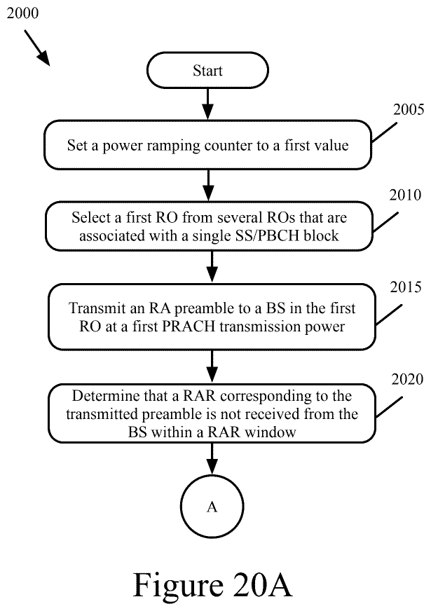

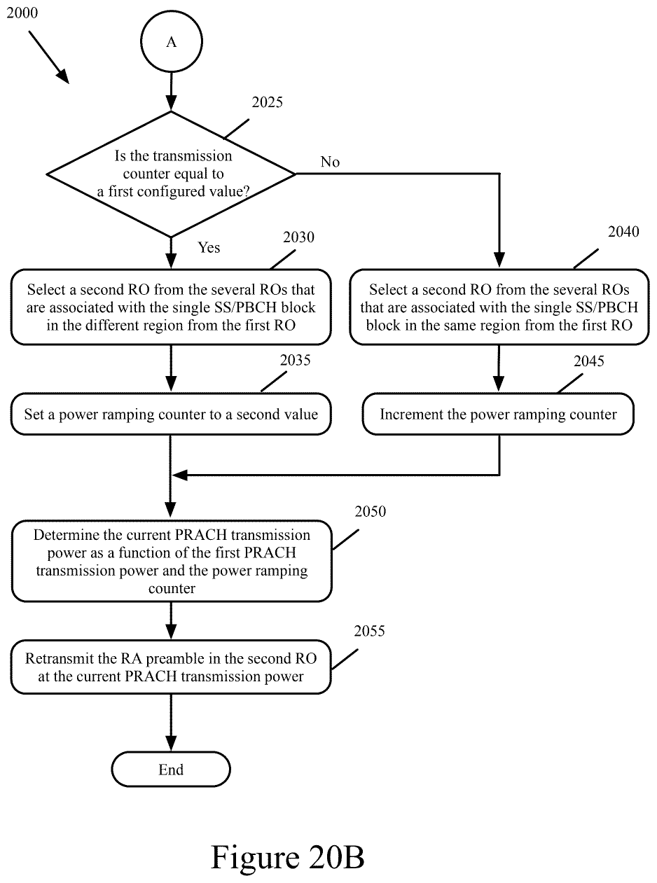

FIGS. 20A-20B illustrate a flowchart of an example method/process 2000 performed by a terminal device to determine the PRACH transmission power using a power ramping counter, according to an example implementation of the present disclosure. The process 2000 may be performed by at least one processor of the terminal device 101, shown in FIGS. 6 and 21.

The process 2000 may set (at block 2005) a power ramping counter to a first value. For example, the process 1500 may select an RO in one of the regions 801-804 or 821-824 shown in FIG. 8. The ROs may be associated with a SS/PBCH block.

The process 2000 may select (at block 2010) a first RO from several ROs that are associated with a single SS/PBCH block. For example, if the first RO may be in one of the regions 801-804 or 821-824.

The process 2000 may transmit (at block 2015) an RA preamble to a BS in the first RO at a first PRACH transmission power. The process 2000 may determine (at block 2020) that a RAR corresponding to the transmitted preamble is not received from the BS within a RAR window

The process 2000 may determine (at block 2025) whether the transmission counter is equal to a first configured value. The first configured value may work as a threshold to determine fallback to the other region for PRACH transmissions. The first configured value is also referred to as the configured maximum number of PRACH transmission attempts for a single region. The first configured value, for example, may be provided via a RRC parameter. In some embodiments, the configured maximum number of PRACH transmission attempts for the SBFD and the non-SBFD regions may be the same. In some embodiments, the configured maximum number of PRACH transmission attempts for the SBFD and the non-SBFD regions may be the different. In these embodiments, the process 2000 may compare (at block 2025) the transmission counter with the value of the configured maximum number of PRACH transmission attempts that corresponds to the region in which the first RO is transmitted.

If the process 2000 determines (at block 2025) that the transmission counter is equal to the first configured value, the process 2000 may select (at block 2030) a next RO from the several ROs that are associated with the single SS/PBCH block in the different region from the first RO. For example, in a case that the first RO is transmitted in the SBFD region (e.g., the RO 1803 shown in FIGS. 18 and 19), the second RO may be transmitted in the non-SBFD region (e.g., the 1804 shown in FIGS. 18 and 19). In a case that the first RO is transmitted in the non-SBFD region, the next RO is transmitted in the SBFD region.

The process 2000 may set (at block 2035) a power ramping counter to a second value. The second value may, for example, be 1 or a value provided via a RRC parameter. The process may then proceed to block 2050, which is described below.

If the process 2000 determines (at block 2025) that the transmission counter is not equal to the first configured value, the process 2000 may select (at block 2040) a second RO from the several ROs that are associated with the single SS/PBCH block in the same region as the first RO.

For example, in a case that the first RO is transmitted in the SBFD region (e.g., the ROs 1801 or 1802 shown in FIGS. 18 and 19), the second RO may also be transmitted in the SBFD region (e.g., the ROs 1802 or 1803). In a case that the first RO is transmitted in the non-SBFD region, the next RO is also transmitted in the non-SBFD region. The process 2000 may increment (at block 2045) the power ramping counter. It should be noted that block 2035 is the fallback to an initial value due to the change of the region, while in block 2045 the power ramping counter for the current region is incremented.

The process 2000 may determine (at block 2050) the current PRACH transmission power as a function of the first PRACH transmission power and the power ramping counter. The process 2000 may retransmit (at block 2060) the RA preamble in the second RO at the current PRACH transmission power. The process 2000 may then end.

Considering the scenarios described with reference to FIGS. 18-19 and 20A-20B, some embodiments the process 1500 may use different alternatives for determining the power transmission of the PRACH in blocks 1520 and 1535.

### Alternative 4: Reuse the Configured Maximum Number of PRACH Transmission Attempts for a Single Region

The process 1500 may determine whether the switching from the first region to the second region in which PRACH transmissions are performed after the number of PRACH transmissions equals to the first configured value are made in the first region. For example, in a case where the switching has been done and the Msg3 PUSCH is scheduled in the first region, the process 1500 may determine (at block 1530) the transmission power of for the PUSCH by applying the configured maximum number of PRACH transmission attempts for a single region to the value of Cₚ in Equation (1).

In a case where the switching has been done and the Msg3 PUSCH is scheduled in the second region, the process 1500 may determine (at block 1535) the transmission power of for the PUSCH by setting Cₚ in Equation (1) to the value of the power ramping counter.

In a case where the switching has not been done yet and the Msg3 PUSCH is scheduled in the first region, the process 1500 may determine (at block 1530) the transmission power of for the PUSCH by setting Cₚ in Equation (1) to the value of the power ramping counter.

In a case where the switching has not been done yet and the Msg3 PUSCH is scheduled in the second region, the process 1500 may determine (at block 1535) the transmission power of for the PUSCH by applying an initial value to the value of C, in Equation (1). For example, the initial value may be 1. For example, the initial value may be provided via a RRC parameter.

### Alternative 5: Use the Configured Initial Value of the Power Ramping Counter

The process 1500 may determine whether the switching from the first region to the second region in which PRACH transmissions are performed after the number of PRACH transmissions equals to the first configured value are made in the first region. For example, in a case where the switching has been done and the Msg3 PUSCH is scheduled in the first region, the process 1500 may determine (at block 1530) the transmission power of for the PUSCH by applying an initial value of the power ramping counter for the SBFD region.

In a case where the switching has been done and the Msg3 PUSCH is scheduled in the second region, the process 1500 may determine (at block 1535) the transmission power of for the PUSCH by setting Cₚ in Equation (1) to the value of the power ramping counter.

In a case where the switching has not been done yet and the Msg3 PUSCH is scheduled in the first region, the process 1500 may determine (at block 1530) the transmission power of for the PUSCH by setting Cₚ in Equation (1) to the value of the power ramping counter.

In a case where the switching has not been done yet and the Msg3 PUSCH is scheduled in the second region, the process 1500 may determine (at block 1535) the transmission power of for the PUSCH by applying an initial value to the value of C, in Equation (1). For example, the initial value may be 1. The initial value, for example, may be provided via a RRC parameter.

Alternative 6: Limit the Msg3 PUSCH Scheduling to the Same Region as the Region in which the Latest PRACH Transmission is Performed

The process 1500, in some embodiments, may assume that the Msg3 PUSCH is scheduled to the same region as the region in which the latest PRACH transmission is performed. In these embodiments, the process 1500 may skip blocks 1525 and 1535. The process 1500 may select the PUSCH occasion in the same region as the last PRACH transmission occasion and may use block 1530 to determine the transmission power of the PUSCH.

FIG. 21 is a block diagram illustrating a node 2100 for wireless communication, according to an example implementation of the present disclosure. As illustrated in FIG. 21, a node 2100 may include a transceiver 2120, a processor 2128, a memory 2134, one or more presentation components 2129, and at least one antenna 2136. The node 2100 may also include a radio frequency (RF) spectrum band module, a BS communications module, a network communications module, and a system communications management module, Input/Output (I/O) ports, I/O components, and a power supply (not illustrated in FIG. 21).

Each of the components may directly or indirectly communicate with each other over one or more buses 2140. The node 2100 may be a UE, a BS, a LMF server, or any other network node on the RAN side or CN side that performs various functions disclosed with reference to FIGS. 1 through 20.

The transceiver 2120 has a transmitter 2122 (e.g., transmitting/transmission circuitry) and a receiver 2124 (e.g., receiving/reception circuitry) and may be configured to transmit and/or receive time and/or frequency resource partitioning information. The transceiver 2120 may be configured to transmit in different types of subframes and slots including, but not limited to, usable, non-usable, and flexibly usable subframes and slot formats. The transceiver 2120 may be configured to receive data and control channels.

The node 2100 may include a variety of computer-readable media. Computer-readable media may be any available media that may be accessed by the node 2100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 2134 may include computer-storage media in the form of volatile and/or non-volatile memory. The memory 2134 may be removable, non-removable, or a combination thereof. Example memory may include solid-state memory, hard drives, optical-disc drives, etc. As illustrated in FIG. 21, the memory 2134 may store a computer-readable and/or computer-executable instructions 2132 (e.g., software codes) that are configured to, when executed, cause the processor 2128 to perform various functions disclosed herein, for example, with reference to FIGS. 1 through 12. Alternatively, the instructions 2132 may not be directly executable by the processor 2128 but may be configured to cause the node 2100 (e.g., when compiled and executed) to perform various functions disclosed herein.

The processor 2128 (e.g., having processing circuitry) may include an intelligent hardware device, e.g., a Central Processing Unit (CPU), a microcontroller, an ASIC, etc. The processor 2128 may include memory. The processor 2128 may process the data 2130 and the instructions 2132 received from the memory 2134, and information transmitted and received via the transceiver 2120, the baseband communications module, and/or the network communications module. The processor 2128 may also process information to send to the transceiver 2120 for transmission via the antenna 2136 to the network communications module for transmission to a CN.

One or more presentation components 2129 may present data indications to a person or another device. Examples of presentation components 2129 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
select a first random access channel occasion (RO) from a first plurality of ROs;
initiate a random access (RA) procedure by transmitting, to a base station (BS), an RA preamble in the first RO;
receive, from the BS, an RA response (RAR) indicating an uplink for a message 3 (Msg3) is not granted;
select a second RO from a second plurality of ROs;
in a case that the first RO is within a subband full duplex (SBFD) region in time domain, calculate a backoff time as a function of a first scaling factor;
in a case that the first RO is within a non-SBFD region in the time domain, calculate the backoff time as a function of a second scaling factor different from the first scaling factor; and
retransmit, to the BS, the RA preamble in the second RO after a duration of the calculated backoff time.

2. The UE of claim 1, wherein:
the RAR comprises a backoff indicator (BI),
calculating the backoff time as a function of the first scaling factor comprises:
calculating a preamble backoff value by multiplying the BI by the first scaling factor, and
selecting the backoff time as a random value between 0 and the preamble backoff value; and
calculating the backoff time as a function of the second scaling factor comprises:
calculating a preamble backoff value by multiplying the BI by the second scaling factor, and
selecting the backoff time as a random value between 0 and the preamble backoff value.

3. The UE of claim 2, wherein the RAR identifies the second RO to be within the SBFD region or the non-SBFD region for the retransmission of the RA preamble.

4. The UE of claim 1, wherein the UE is one of a plurality of UEs to which the RAR is broadcast by the BS.

5. The UE of claim 1, wherein the at least one processor is further configured to execute the one or more computer-executable instructions to cause the UE to:
receive, from the BS, the first scaling factor, as a first radio resource control (RRC) parameter associated with the SBFD region; and
receive, from the BS, the second scaling factor, as a second RRC parameter associated with the non-SBFD region, wherein the first and second RRC parameters are received via one or more RRC messages.

6. The UE of claim 1, wherein the at least one processor is further configured to execute the one or more computer-executable instructions to cause the UE to:
receive, from the BS, a second RAR corresponding to the retransmitted RA preamble within a RAR time window, the second RAR comprising an uplink grant for a message 3 (Msg3) of the RA procedure; and
transmit, to the BS, the Msg3 in response to receiving the second RAR.

7. The UE of claim 1, wherein the at least one processor is further configured to execute the one or more computer-executable instructions to cause the UE to:
for a number of times and before reaching a maximum number of RA preamble transmission attempts, iteratively:
receive, from the BS, an RAR indicating an uplink for a message 3 (Msg3) is not granted;
select a next RO for transmission of the RA preamble;
in a case that an immediately transmitted RO is within the SBFD region in the time domain, calculate the backoff time as a function of the first scaling factor,
in a case that the immediately transmitted RO is within the non-SBFD region in the time domain, calculate the backoff time as a function of the second scaling factor, and
retransmit, to the BS, the RA preamble in the next RO after a duration of the calculated backoff time.

8. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
select a first random access channel occasion (RO) from a first plurality of ROs;
initiate a random access (RA) procedure by transmitting, to a base station (BS), an RA preamble in the first RO;
receive, from the BS, an RA response (RAR) indicating an uplink for a message 3 (Msg3) is not granted;
select a second RO from a second plurality of ROs;
in a case that the RAR is received within a subband full duplex (SBFD) region in time domain, calculate a backoff time as a function of a first scaling factor;
in a case that the RAR is received within the non-SBFD region in the time domain, calculate the backoff time as a function of a second scaling factor different than the first scaling factor; and
retransmit, to the BS, the RA preamble in the second RO after a duration of the calculated backoff time.

9. The UE of claim 8, wherein:
the RAR comprises a backoff indicator (BI),
calculating the backoff time as a function of the first scaling factor comprises:
calculating a preamble backoff value by multiplying the BI by the first scaling factor, and
selecting the backoff time as a random value between 0 and the preamble backoff value; and
calculating the backoff time as a function of the second scaling factor comprises:
calculating a preamble backoff value by multiplying the BI by the second scaling factor, and
selecting the backoff time as a random value between 0 and the preamble backoff value.

10. The UE of claim 9, wherein the RAR identifies the second RO to be within the SBFD or the non-SBFD region for the retransmission of the RA preamble.

11. The UE of claim 8, wherein the UE is one of a plurality of UEs to which the RAR is broadcast by the BS.

12. The UE of claim 8, wherein the at least one processor is further configured to execute the one or more computer-executable instructions to cause the UE to:
receive, from the BS, the first scaling factor as a radio resource control (RRC) parameter associated with the SBFD region, and
the second scaling factor is received, from the BS, as an RRC parameter associated with the non-SBFD region, wherein the first and second RRC parameters are received via one or more RRC messages.

13. The UE of claim 8, wherein the at least one processor is further configured to execute the one or more computer-executable instructions to cause the UE to:
receive, from the BS, a second RAR corresponding to the retransmitted RA preamble within a RAR time window, the second RAR comprising an uplink grant for a message 3 (Msg3) of the RA procedure; and
transmit, to the BS, the Msg3 in response to receiving the second RAR.

14. The UE of claim 8, wherein the at least one processor is further configured to execute the one or more computer-executable instructions to cause the UE to:
for a number of times and before reaching a maximum number of RA preamble transmission attempts, iteratively:
receive, from the BS, an RAR indicating an uplink for a message 3 (Msg3) is not granted;
select a next RO for transmission of the RA preamble;
in a case that a last RAR is received within the SBFD region in the time domain, calculate the backoff time as a function of a first scaling factor;
in a case that the last RAR is received within the non-SBFD region in the time domain, calculate the backoff time as a function of a second scaling factor different than the first scaling factor; and
retransmit, to the BS, the RA preamble in the next RO after a duration of the calculated backoff time.

15. A method, comprising:
selecting, by a user equipment (UE), a first random access channel occasion (RO) from a first plurality of ROs;
initiating, by the UE, a random access (RA) procedure by transmitting, to a base station (BS), an RA preamble in the first RO;
receiving, from the BS, an RA response (RAR) indicating an uplink for a message 3 (Msg3) is not granted;
selecting a second RO from the second plurality of ROs;
in a case that the first RO is within a subband full duplex (SBFD) region in time domain, calculating a backoff time as a function of a first scaling factor;
in a case that the first RO is within a non-SBFD region in the time domain, calculating the backoff time as a function of a second scaling factor different from the first scaling factor; and
retransmitting, to the BS, the RA preamble in the second RO after a duration of the calculated backoff time.
